(19) United States
(12) Patent Application Publication
(10) Pub. No.: US 2025/0020043 A1
(43) Pub. Date: Jan. 16, 2025

(54) HYDRATE OPERATIONS SYSTEM

(71) Applicant: Schlumberger Technology Corporation, Sugar Land, TX (US)

(72) Inventors: Taoufik Manai, Paris (FR); Mohamed Osman Mahgoub Ahmed, Abu Dhabi (AE)

(21) Appl. No.: 18/712,037

(22) PCT Filed: Nov. 30, 2022
(86) PCT No.: PCT/US2022/051401

§ 371 Date: May 21, 2024

Related U.S. Application Data
(60) Provisional application No. 63/284,531, filed on Nov. 30, 2021.

(51) Int. Cl. E21B 41/00; E21B 43/16

(52) U.S. Cl. CPC E21B 41/0099; E21B 41/0064; E21B 43/164; E21B 2200/20; E21B 2200/22

(57) ABSTRACT

A method can include performing a reservoir simulation for injection of carbon dioxide into a reservoir via an injection well: during the performing, accessing a trained machine learning model that outputs hydrate information based on reservoir conditions; and, based on the hydrate information, generating reservoir simulation results that indicate an amount of the carbon dioxide sequestered in the reservoir.

### RELATED APPLICATION

This application claims priority to and the benefit of a U.S. Provisional Application having Ser. No. 63/284,531, filed 30 Nov. 2021, which is incorporated by reference herein in its entirety.

### BACKGROUND

A reservoir can be a subsurface formation that can be characterized at least in part by its porosity and fluid permeability. As an example, a reservoir may be part of a basin such as a sedimentary basin. A basin can be a depression (e.g., caused by plate tectonic activity, subsidence, etc.) in which sediments accumulate. As an example, where hydrocarbon source rocks occur in combination with appropriate depth and duration of burial, a petroleum system may develop within a basin, which may form a reservoir that includes hydrocarbon fluids (e.g., oil, gas, etc.).

In oil and gas exploration, geoscientists and engineers may acquire and analyze data to identify and locate various subsurface structures (e.g., horizons, faults, geobodies, etc.) in a geologic environment. Various types of structures (e.g., stratigraphic formations) may be indicative of hydrocarbon traps or flow channels, as may be associated with one or more reservoirs (e.g., fluid reservoirs). In the field of resource extraction, enhancements to interpretation can allow for construction of a more accurate model of a subsurface region, which, in turn, may improve characterization of the subsurface region for purposes of resource extraction. Characterization of one or more subsurface regions in a geologic environment can guide, for example, performance of one or more operations (e.g., field operations, etc.).

In various geologic environments, hydrates may exist, form, or dissipate. Hydrates are white, solid, ice-like substances that form at elevated pressures and low temperatures because of an interaction between a liquid water phase and one or more light gas components. Under certain circumstances, water can separate from gas and condense as temperature and pressure change, which may occur along a production transport system and result in hydrate formation. Hydrate formation is generally viewed as unfavorable in most cases since it represents a challenge for flow assurance and production system integrity. Over time, formation, deposition, and adsorption of hydrates on internal surfaces of pipes, wellbore, processing facilities, and piping components can restrict and disrupt hydrocarbon production, and in worst cases, cease production.

Hydrates involves water and molecules smaller than n-pentane. When small (e.g., less than 9 Å) nonpolar molecules contact water at ambient temperatures (e.g., less than 100 degrees F.) and moderate pressures (e.g., greater than 180 psia), a water crystal form may appear in the form of a clathrate hydrate.

In the petroleum industry, clathrate hydrate technological areas include: safety and flow assurance in oil/gas drilling, production, and transmission lines; stranded-gas transmission to market in a hydrated state; seafloor stability, affecting subsea-equipment foundations and climate; and energy recovery from hydrates in permafrost and in deep-sea locations.

While various detrimental aspects of hydrates are mentioned, hydrates can offer opportunities. For example, consider production of methane from hydrates and sequestration of carbon dioxide by hydrates. Benefits and detriments of hydrates can be challenging to assess due to a lack of resources to make such assessments. For example, given that hydrates are solids, to account for hydrates, a reservoir simulator can include capabilities for handling a solid phase, along with hydrate formation, hydrate dissipation, or both hydrate formation and hydrate dissipation. While predictions of hydrate formation conditions may be made using a phase equilibria flash or Gibbs free-energy package that relies on a hydrate equation of state (EOS), such a package is extremely complex, demanding of considerable time and resources for development and execution. Thus, reliance on such a package for purposes of simulations as to one or more types of hydrate phenomena can be impractical. To reduce complexity, another approach relies on major assumptions to arrive at a simple tank based model; however, that model demonstrated an inability to match most aspects of field test data.

As such, there is no efficient approach to characterize hydrates for purposes of reservoir simulation, particularly for simulation of swapping between carbon dioxide and methane in a reservoir responsive to field operations.

### SUMMARY

A method can include performing a reservoir simulation for injection of carbon dioxide into a reservoir via an injection well; during the performing, accessing a trained machine learning model that outputs hydrate information based on reservoir conditions; and, based on the hydrate information, generating reservoir simulation results that indicate an amount of the carbon dioxide sequestered in the reservoir. A system can include one or more processors; a memory accessible to at least one of the one or more processors; processor-executable instructions stored in the memory and executable to instruct the system to: perform a reservoir simulation for injection of carbon dioxide into a reservoir via an injection well; during the reservoir simulation, access a trained machine learning model that outputs hydrate information based on reservoir conditions; and, based on the hydrate information, generate reservoir simulation results that indicate an amount of the carbon dioxide sequestered in the reservoir. One or more computer-readable storage media can include processor-executable instructions to instruct a computing system to: perform a reservoir simulation for injection of carbon dioxide into a reservoir via an injection well; during the simulation, access a trained machine learning model that outputs hydrate information based on reservoir conditions; and, based on the hydrate information, generate reservoir simulation results that indicate an amount of the carbon dioxide sequestered in the reservoir. Various other apparatuses, systems, methods, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example system that includes various framework components associated with one or more geologic environments;

FIG. 2 illustrates examples of equipment in an environment and an example of a computing system;

FIG. 3 illustrates an example of a wellsite system and an example of a computing system;

FIG. 4 illustrates examples of equipment and an example of a system;

FIG. 5 illustrates an example of a system;

FIG. 6 illustrates example graphics of hydrates;

FIG. 7 illustrates example graphics of hydrates and an example of a phase diagram;

FIG. 8 illustrates examples of phase diagrams;

FIG. 9 illustrates an example of a map of locations pertaining to hydrates;

FIG. 10 illustrates example graphics of processes;

FIG. 11 illustrates examples of plots of data from a field process;

FIG. 12 illustrates an example of a graphical user interface of a trained machine learning model;

FIG. 13 illustrates an example architecture of a machine learning model and example results of predicted versus measured equilibrium pressures;

FIG. 14 illustrates an example architecture of a machine learning model;

FIG. 15 illustrates views of an example of a reservoir simulation model;

FIG. 16 illustrates an example of a method;

FIG. 17 illustrates an example of a staged process;

FIG. 18 illustrates an example of a method and an example of a system; and

FIG. 19 illustrates example components of a system and a networked system.

### DETAILED DESCRIPTION

This description is not to be taken in a limiting sense, but rather is made merely for the purpose of describing the general principles of the implementations. The scope of the described implementations should be ascertained with reference to the issued claims.

As described herein, a machine learning model can be built using data from one or more sources and operatively coupled to a reservoir simulator where the built machine learning model can make predictions as to hydrates (e.g., predicted hydrate information). In such an approach, hydrate statics and/or dynamics can be predicted to enable scenarios such as replacement of methane by carbon dioxide as a guest molecule in hydrates.

As an example, a reservoir simulator can include one or more features of the INTERSECT reservoir simulator (SLB, Houston, Texas). Through machine learning model integration, such a simulator can, for a given formation, provide a powerful and robust way to determine how much carbon dioxide can be trapped in a hydrate phase, for example, while producing methane (e.g., substituting carbon dioxide for methane). Such a simulation can provide indications as to how much carbon dioxide can be stored in a hydrate form, which can offer a safe trapping mechanism for carbon sequestration purposes. A machine learning model can provide for phase labelling that promotes thermodynamic understanding as to where and how carbon dioxide can be sequestered in a reservoir. A machine learning model approach can reduce study time while screening for one or more subsurface formations that can hold a substantial amount of carbon dioxide, for example, by displacing methane where the displaced methane may be produced (e.g., as an energy source). Storing carbon dioxide in a hydrate phase can be a cost-effective solution as it can demand less monitoring and can be safer than carbon dioxide sequestration in a supercritical state.

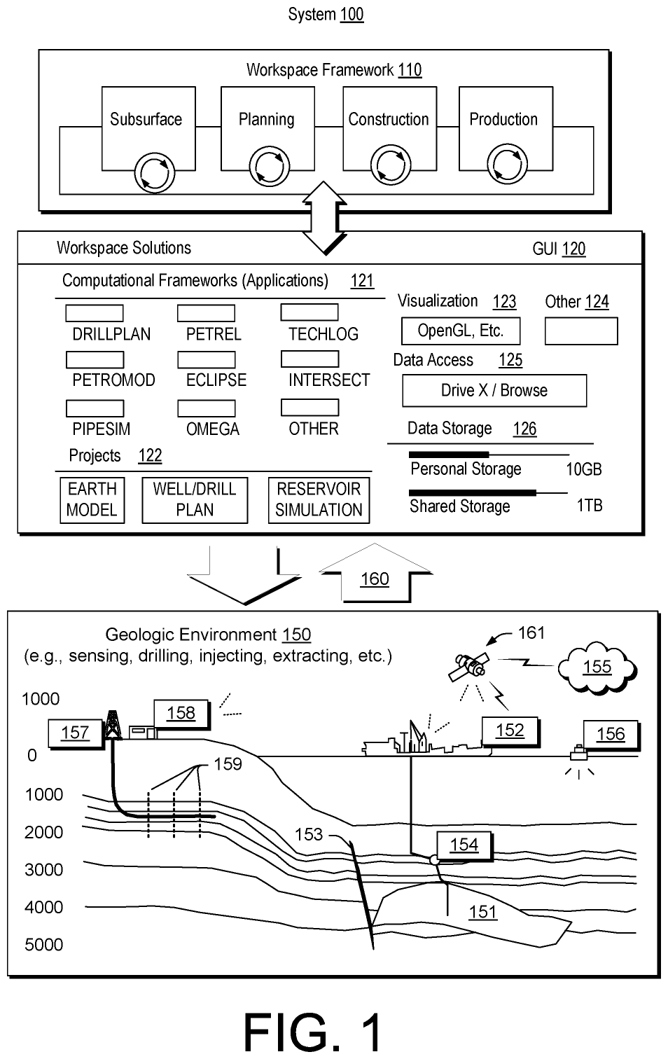

FIG. 1 shows an example of a system 100 that includes a workspace framework 110 that can provide for instantiation of, rendering of, interactions with, etc., a graphical user interface (GUI) 120. In the example of FIG. 1, the GUI 120 can include graphical controls for computational frameworks (e.g., applications) 121, projects 122, visualization 123, one or more other features 124, data access 125, and data storage 126.

In the example of FIG. 1, the workspace framework 110 may be tailored to a particular geologic environment such as an example geologic environment 150. For example, the geologic environment 150 may include layers (e.g., stratification) that include a reservoir 151 and that may be intersected by a fault 153. As an example, the geologic environment 150 may be outfitted with a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a wellsite and include sensing, detecting, emitting, or other circuitry. Such equipment may include storage and communication circuitry to store and to communicate data, instructions, etc. As an example, one or more satellites 161 may be provided for purposes of communications, data acquisition, etc. For example, FIG. 1 shows the satellite 161 in communication with the network 155 that may be configured for communications, noting that the satellite 161 may additionally or alternatively include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc., to develop a laterally extensive reservoir (e.g., via fracturing, injecting, extracting, etc.). As an example, the equipment 157 and/or 158 may include components, a system, systems, etc., for fracturing, seismic sensing, analysis of seismic data, assessment of one or more fractures, etc.

As an example, a system may include a computational environment that can include various features of the DELFI environment (SLB, Houston, Texas), which may be referred to as the DELFI framework, which may be a framework of frameworks. As an example, the DELFI framework can include various other frameworks, which can include, for example, one or more types of models (e.g., simulation models, etc.). Some examples of frameworks can include the DRILLPLAN, PETREL, TECHLOG, PIPESIM, ECLIPSE, INTERSECT, VISAGE, MANGROVE, OMEGA and PETROMOD frameworks (SLB, Houston, Texas).

As an example, a system may include features of a simulation framework that provides components that allow for optimization of exploration and development operations (e.g., “E&P” operations). A framework may include seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of simulating a geologic environment, decision making, operational control, etc.).

As an example, a system may include add-ons or plug-ins that operate according to specifications of a framework environment. As an example, various components may be implemented as add-ons (or plug-ins) that conform to and operate according to specifications of a framework environment (e.g., according to application programming interface (API) specifications, etc.).

The aforementioned DELFI environment is a secure, cognitive, cloud-based collaborative environment that integrates data and workflows with digital technologies, such as artificial intelligence and machine learning. As an example, such an environment can provide for operations that involve one or more computational frameworks. For example, various types of computational frameworks may be utilized within an environment such as a drilling plan framework, a seismic-to-simulation framework, a measurements framework, a mechanical earth modeling (MEM) framework, an exploration risk, resource, and value assessment framework, a reservoir simulation framework, a surface facilities framework, a stimulation framework, etc. As an example, one or more methods may be implemented at least in part via a framework (e.g., a computational framework) and/or an environment (e.g., a computational environment).

In the example of FIG. 1, the GUI 120 shows examples of computational frameworks, including the DRILLPLAN, PETREL, TECHLOG, PETROMOD, ECLIPSE, INTERSECT, PIPESIM and OMEGA frameworks that may be part of a DELFI environment.

The DRILLPLAN framework provides for digital well construction planning and includes features for automation of repetitive tasks and validation workflows, enabling improved quality drilling programs (e.g., digital drilling plans, etc.) to be produced quickly with assured coherency.

The PETREL framework can provide for implementing various tasks in geosciences and geoengineering, for example, to analyze subsurface data from exploration to production of fluid from a reservoir.

The TECHLOG framework can handle and process field and laboratory data for a variety of geologic environments (e.g., deepwater exploration, shale, etc.). The TECHLOG framework can structure wellbore data for analyses, planning, etc.

The PETROMOD framework provides petroleum systems modeling capabilities that can combine one or more of seismic, well, and geological information to model the evolution of a sedimentary basin. The PETROMOD framework can predict if, and how, a reservoir has been charged with hydrocarbons, including the source and timing of hydrocarbon generation, migration routes, quantities, and hydrocarbon type in the subsurface or at surface conditions.

The ECLIPSE framework provides a reservoir simulator (e.g., as a computational framework) with numerical solutions for fast and accurate prediction of dynamic behavior for various types of reservoirs and development schemes.

The INTERSECT framework provides a high-resolution reservoir simulator for simulation of detailed geological features and quantification of uncertainties, for example, by creating accurate production scenarios and, with the integration of precise models of the surface facilities and field operations, the INTERSECT framework can produce reliable results, which may be continuously updated by real-time data exchanges (e.g., from one or more types of data acquisition equipment in the field that can acquire data during one or more types of field operations, etc.). The INTERSECT framework can provide completion configurations for complex wells where such configurations can be built in the field, can provide detailed enhanced-oil-recovery (EOR) formulations where such formulations can be implemented in the field, can analyze application of steam injection and other thermal EOR techniques for implementation in the field, advanced production controls in terms of reservoir coupling and flexible field management, and flexibility to script customized solutions for improved modeling and field management control. The INTERSECT framework, as with the other example frameworks, may be utilized as part of the DELFI cognitive E&P environment, for example, for rapid simulation of multiple concurrent cases. For example, a workflow may utilize one or more of the DELFI on demand reservoir simulation features.

The PIPESIM simulator includes solvers that may provide simulation results such as, for example, multiphase flow results (e.g., from a reservoir to a wellhead and beyond, etc.), flowline and surface facility performance, etc. The PIPESIM simulator may be integrated, for example, with the AVOCET production operations framework (SLB, Houston Texas). As an example, a reservoir or reservoirs may be simulated with respect to one or more enhanced recovery techniques (e.g., consider a thermal process such as steam-assisted gravity drainage (SAGD), etc.). As an example, the PIPESIM simulator may be an optimizer that can optimize one or more operational scenarios at least in part via simulation of physical phenomena.

The OMEGA framework includes finite difference modelling (FDMOD) features for two-way wavefield extrapolation modelling, generating synthetic shot gathers with and without multiples. The FDMOD features can generate synthetic shot gathers by using full 3D, two-way wavefield extrapolation modelling, which can utilize wavefield extrapolation logic matches that are used by reverse-time migration (RTM). A model may be specified on a dense 3D grid as velocity and optionally as anisotropy, dip, and variable density. The OMEGA framework also includes features for RTM, FDMOD, adaptive beam migration (ABM), Gaussian packet migration (Gaussian PM), depth processing (e.g., Kirchhoff prestack depth migration (KPSDM), tomography (Tomo)), time processing (e.g., Kirchhoff prestack time migration (KPSTM), general surface multiple prediction (GSMP), extended interbed multiple prediction (XIMP)), framework foundation features, desktop features (e.g., GUIs, etc.), and development tools. Various features can be included for processing various types of data such as, for example, one or more of: land, marine, and transition zone data; time and depth data; 2D, 3D, and 4D surveys; isotropic and anisotropic (TTI and VTI) velocity fields; and multicomponent data.

The aforementioned DELFI environment provides various features for workflows as to subsurface analysis, planning, construction and production, for example, as illustrated in the workspace framework 110. As shown in FIG. 1, outputs from the workspace framework 110 can be utilized for directing, controlling, etc., one or more processes in the geologic environment 150 and, feedback 160, can be received via one or more interfaces in one or more forms (e.g., acquired data as to operational conditions, equipment conditions, environment conditions, etc.).

In the example of FIG. 1, the visualization features 123 may be implemented via the workspace framework 110, for example, to perform tasks as associated with one or more of subsurface regions, planning operations, constructing wells and/or surface fluid networks, and producing from a reservoir.

As an example, a visualization process can implement one or more of various features that can be suitable for one or more web applications. For example, a template may involve use of the JAVASCRIPT object notation format (JSON) and/or one or more other languages/formats. As an example, a framework may include one or more converters. For example, consider a JSON to PYTHON converter and/or a PYTHON to JSON converter. Such a converter may provide for interoperability, integration of code from one or more sources, etc.

As an example, visualization features can provide for visualization of various earth models, properties, etc., in one or more dimensions. As an example, visualization features can provide for rendering of information in multiple dimensions, which may optionally include multiple resolution rendering. In such an example, information being rendered may be associated with one or more frameworks and/or one or more data stores. As an example, visualization features may include one or more control features for control of equipment, which can include, for example, field equipment that can perform one or more field operations. As an example, a workflow may utilize one or more frameworks to generate information that can be utilized to control one or more types of field equipment (e.g., drilling equipment, wireline equipment, fracturing equipment, etc.). As an example, a visualization framework such as the OpenGL framework (Khronos Group, Beaverton, Oregon) may be utilized for visualizations. The OpenGL framework provides a cross-language, cross-platform application programming interface for rendering 2D and 3D vector graphics where the API may be used to interact with a graphics processing unit (or units), to achieve hardware-accelerated rendering.

As to a reservoir model that may be suitable for utilization by a simulator, consider acquisition of seismic data as acquired via reflection seismology, which finds use in geophysics, for example, to estimate properties of subsurface formations. As an example, reflection seismology may provide seismic data representing waves of elastic energy (e.g., as transmitted by P-waves and S-waves, in a frequency range of approximately 1 Hz to approximately 100 Hz). Seismic data may be processed and interpreted, for example, to understand better composition, fluid content, extent and geometry of subsurface rocks. Such interpretation results can be utilized to plan, simulate, perform, etc., one or more operations for production of fluid from a reservoir (e.g., reservoir rock, etc.).

Field acquisition equipment may be utilized to acquire seismic data, which may be in the form of traces where a trace can include values organized with respect to time and/or depth (e.g., consider 1D, 2D, 3D or 4D seismic data). For example, consider acquisition equipment that acquires digital samples at a rate of one sample per approximately 4 ms. Given a speed of sound in a medium or media, a sample rate may be converted to an approximate distance. For example, the speed of sound in rock may be on the order of around 5 km per second. Thus, a sample time spacing of approximately 4 ms would correspond to a sample “depth” spacing of about 10 meters (e.g., assuming a path length from source to boundary and boundary to sensor). As an example, a trace may be about 4 seconds in duration; thus, for a sampling rate of one sample at about 4 ms intervals, such a trace would include about 1000 samples where latter acquired samples correspond to deeper reflection boundaries. If the 4 second trace duration of the foregoing example is divided by two (e.g., to account for reflection), for a vertically aligned source and sensor, a deepest boundary depth may be estimated to be about 10 km (e.g., assuming a speed of sound of about 5 km per second).

As an example, a model may be a simulated version of a geologic environment. As an example, a simulator may include features for simulating physical phenomena in a geologic environment based at least in part on a model or models. A simulator, such as a reservoir simulator, can simulate fluid flow in a geologic environment based at least in part on a model that can be generated via a framework that receives seismic data. A simulator can be a computerized system (e.g., a computing system) that can execute instructions using one or more processors to solve a system of equations that describe physical phenomena subject to various constraints. In such an example, the system of equations may be spatially defined (e.g., numerically discretized) according to a spatial model that that includes layers of rock, geobodies, etc., that have corresponding positions that can be based on interpretation of seismic and/or other data. A spatial model may be a cell-based model where cells are defined by a grid (e.g., a mesh). A cell in a cell-based model can represent a physical area or volume in a geologic environment where the cell can be assigned physical properties (e.g., permeability, fluid properties, etc.) that may be germane to one or more physical phenomena (e.g., fluid volume, fluid flow, pressure, etc.). A reservoir simulation model can be a spatial model that may be cell-based.

A simulator can be utilized to simulate the exploitation of a real reservoir, for example, to examine different productions scenarios to find an optimal one before production or further production occurs. A reservoir simulator does not provide an exact replica of flow in and production from a reservoir at least in part because the description of the reservoir and the boundary conditions for the equations for flow in a porous rock are generally known with an amount of uncertainty. Certain types of physical phenomena occur at a spatial scale that can be relatively small compared to size of a field. A balance can be struck between model scale and computational resources that results in model cell sizes being of the order of meters; rather than a lesser size (e.g., a level of detail of pores). A modeling and simulation workflow for multiphase flow in porous media (e.g., reservoir rock, etc.) can include generalizing real micro-scale data from macro scale observations (e.g., seismic data and well data) and upscaling to a manageable scale and problem size. Uncertainties can exist in input data and solution procedure such that simulation results too are to some extent uncertain. A process known as history matching can involve comparing simulation results to actual field data acquired during production of fluid from a field. Information gleaned from history matching, can provide for adjustments to a model, data, etc., which can help to increase accuracy of simulation.

As an example, a simulator may utilize various types of constructs, which may be referred to as entities. Entities may include earth entities or geological objects such as wells, surfaces, reservoirs, etc. Entities can include virtual representations of actual physical entities that may be reconstructed for purposes of simulation. Entities may include entities based on data acquired via sensing, observation, etc. (e.g., consider entities based at least in part on seismic data and/or other information). As an example, an entity may be characterized by one or more properties (e.g., a geometrical pillar grid entity of an earth model may be characterized by a porosity property, etc.). Such properties may represent one or more measurements (e.g., acquired data), calculations, etc.

As an example, a simulator may utilize an object-based software framework, which may include entities based on pre-defined classes to facilitate modeling and simulation. As an example, an object class can encapsulate reusable code and associated data structures. Object classes can be used to instantiate object instances for use by a program, script, etc. For example, borehole classes may define objects for representing boreholes based on well data. A model of a basin, a reservoir, etc. may include one or more boreholes where a borehole may be, for example, for measurements, injection, production, etc. As an example, a borehole may be a wellbore of a well, which may be a completed well (e.g., for production of a resource from a reservoir, for injection of material, etc.).

While several simulators are illustrated in the example of FIG. 1, one or more other simulators may be utilized, additionally or alternatively. For example, consider the VISAGE geomechanics simulator, etc. The VISAGE simulator includes finite element numerical solvers that may provide simulation results such as, for example, results as to compaction and subsidence of a geologic environment, well and completion integrity in a geologic environment, cap-rock and fault-seal integrity in a geologic environment, fracture behavior in a geologic environment, thermal recovery in a geologic environment, CO₂ disposal, etc. The MANGROVE simulator provides for optimization of stimulation design (e.g., stimulation treatment operations such as hydraulic fracturing) in a reservoir-centric environment. The MANGROVE framework can combine scientific and experimental work to predict geomechanical propagation of hydraulic fractures, reactivation of natural fractures, etc., along with production forecasts within 3D reservoir models (e.g., production from a drainage area of a reservoir where fluid moves via one or more types of fractures to a well and/or from a well). The MANGROVE framework can provide results pertaining to heterogeneous interactions between hydraulic and natural fracture networks, which may assist with optimization of the number and location of fracture treatment stages (e.g., stimulation treatment(s)), for example, to increased perforation efficiency and recovery.

The PETREL framework provides components that allow for optimization of exploration and development operations. The PETREL framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes (e.g., with respect to one or more geologic environments, etc.). Such a framework may be considered an application (e.g., executable using one or more devices) and may be considered a data-driven application (e.g., where data is input for purposes of modeling, simulating, etc.).

As mentioned, a framework may be implemented within or in a manner operatively coupled to the DELFI environment. As an example, the DELFI framework can include various other frameworks, which can include, for example, one or more types of models (e.g., simulation models, machine learning models, etc.).

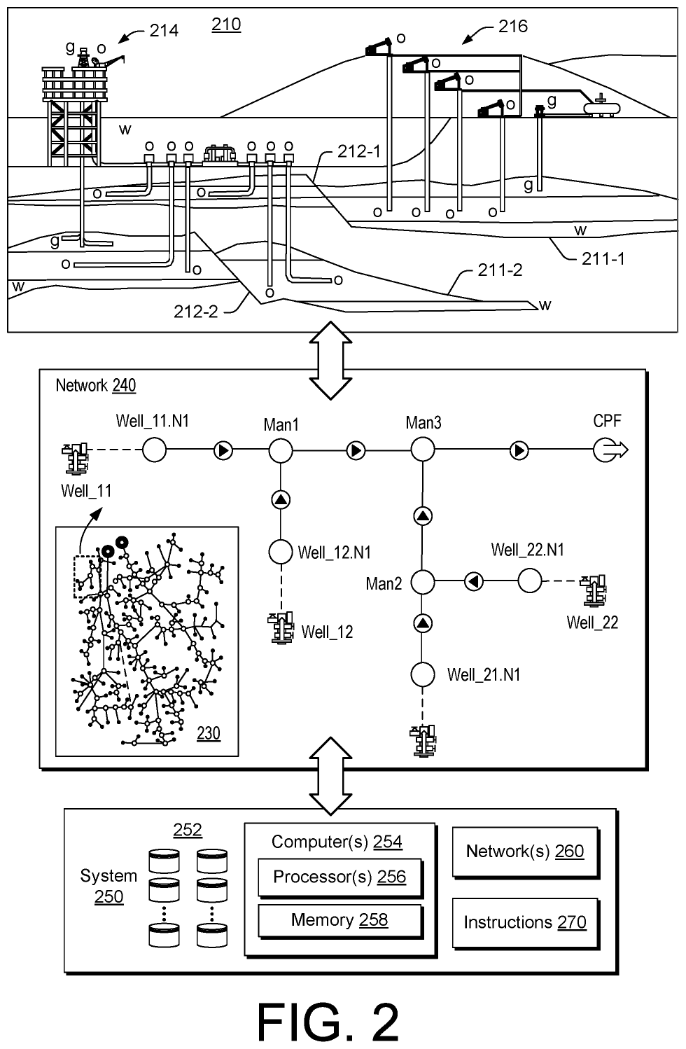

FIG. 2 shows an example of a geologic environment 210 that includes reservoirs 211-1 and 211-2, which may be faulted by faults 212-1 and 212-2, an example of a network of equipment 230, an enlarged view of a portion of the network of equipment 230, referred to as network 240, and an example of a system 250. FIG. 2 shows examples of offshore equipment 214 for oil and gas operations related to the reservoir 211-2 and onshore equipment 216 for oil and gas operations related to the reservoir 211-1.

In FIG. 2, the network 240 can be an example of a relatively small production system network. As shown, the network 240 forms somewhat of a tree like structure where flowlines represent branches (e.g., segments) and junctions represent nodes. As shown in FIG. 2, the network 240 provides for transportation of oil and gas fluids from well locations along flowlines interconnected at junctions with final delivery at a central processing facility.

In the example of FIG. 2, various portions of the network 240 may include conduit. For example, consider a perspective view of a geologic environment that includes two conduits which may be a conduit to Man1 and a conduit to Man3 in the network 240.

As shown in FIG. 2, the example system 250 includes one or more information storage devices 252, one or more computers 254, one or more networks 260, and instructions 270 (e.g., organized as one or more sets of instructions). As to the one or more computers 254, each computer may include one or more processors (e.g., or processing cores) 256 and memory 258 for storing the instructions 270 (e.g., one or more sets of instructions), for example, executable by at least one of the one or more processors. As an example, a computer may include one or more network interfaces (e.g., wired or wireless), one or more graphics cards, a display interface (e.g., wired or wireless), etc. As an example, imagery such as surface imagery (e.g., satellite, geological, geophysical, etc.) may be stored, processed, communicated, etc. As an example, data may include SAR data, GPS data, etc. and may be stored, for example, in one or more of the storage devices 252. As an example, information that may be stored in one or more of the storage devices 252 may include information about equipment, location of equipment, orientation of equipment, fluid characteristics, etc.

As an example, the instructions 270 can include instructions (e.g., stored in the memory 258) executable by at least one of the one or more processors 256 to instruct the system 250 to perform various actions. As an example, the system 250 may be configured such that the instructions 270 provide for establishing a framework, for example, that can perform network modeling (see, e.g., the PIPESIM framework of the example of FIG. 1, etc.). As an example, one or more methods, techniques, etc. may be performed using one or more sets of instructions, which may be, for example, the instructions 270 of FIG. 2.

As an example, a model may be made that models a geologic environment in combination with equipment, wells, etc. For example, a model may be a flow simulation model for use by a simulator to simulate flow in an oil, gas or oil and gas production system. Such a flow simulation model may include equations, for example, to model multiphase flow from a reservoir to a wellhead, from a wellhead to a reservoir, etc. A flow simulation model may also include equations that account for flowline and surface facility performance, for example, to perform a comprehensive production system analysis.

As an example, a flow simulation model may be a network model that includes various sub-networks specified using nodes, segments, branches, etc. As an example, a flow simulation model may be specified in a manner that provides for modeling of branched segments, multilateral segments, complex completions, intelligent downhole controls, etc. As an example, one or more portions of a production network (e.g., optionally sub-networks, etc.) or a group of signal components and/or controllers may be modeled as sub-models.

As an example, a system may provide for transportation of oil and gas fluids from well locations to processing facilities and may represent a substantial investment in infrastructure with both economic and environmental impact. Simulation of such a system, which may include hundreds or thousands of flow lines and production equipment interconnected at junctions to form a network, can involve multiphase flow science and, for example, use of engineering and mathematical techniques for large systems of equations.

As an example, a flow simulation model may include equations for performing nodal analysis, pressure-volume-temperature (PVT) analysis, gas lift analysis, erosion analysis, corrosion analysis, production analysis, injection analysis, etc. In such an example, one or more analyses may be based, in part, on a simulation of flow in a modeled network.

As to nodal analysis, it may provide for evaluation of well performance, for making decisions as to completions, etc. A nodal analysis may provide for an understanding of behavior of a system and optionally sensitivity of a system (e.g., production, injection, production and injection). For example, a system variable may be selected for investigation and a sensitivity analysis performed. Such an analysis may include plotting inflow and outflow of fluid at a nodal point or nodal points in the system, which may indicate where certain opportunities exist (e.g., for injection, for production, etc.).

A modeling framework may include instructions (e.g., processor-executable instructions) to facilitate generation of a flow simulation model. For example, instructions may provide for modeling completions for vertical wells, completions for horizontal wells, completions for fractured wells, etc. A modeling framework may include instructions for particular types of equations, for example, black-oil equations, equation-of-state (EOS) equations, etc. A modeling framework may include instructions for artificial lift, for example, to model fluid injection, fluid pumping, etc. As an example, consider a set of instructions (e.g., a component) that includes features for modeling one or more electric submersible pumps (ESPs) (e.g., based in part on pump performance curves, motors, cables, etc.).

As an example, an analysis using a flow simulation model may be a network analysis to: identify production bottlenecks and constraints; assess benefits of new wells, additional pipelines, compression systems, etc.; calculate deliverability from field gathering systems; predict pressure and temperature profiles through flow paths; or plan full-field development.

As an example, a flow simulation model may provide for analyses with respect to future times, for example, to allow for optimization of production equipment, injection equipment, etc. As an example, consider an optimal time-based and conditional-event logic representation for daily field development operations that can be used to evaluate drilling of new developmental wells, installing additional processing facilities over time, choke-adjusted wells to meet production and operating limits, shutting in of depleting wells as reservoir conditions decline, etc.

As to equations, sets of conservation equations for mass momentum and energy describing single, two or three phase flow (e.g., according to one or more of a LEDAFLOW (Kongsberg Oil & Gas Technologies AS, Sandvika, Norway), OLGA model (SLB, Houston, Texas), TUFFP unified mechanistic models (Tulsa University Fluid Flow Projects, Tulsa, Oklahoma), etc.).

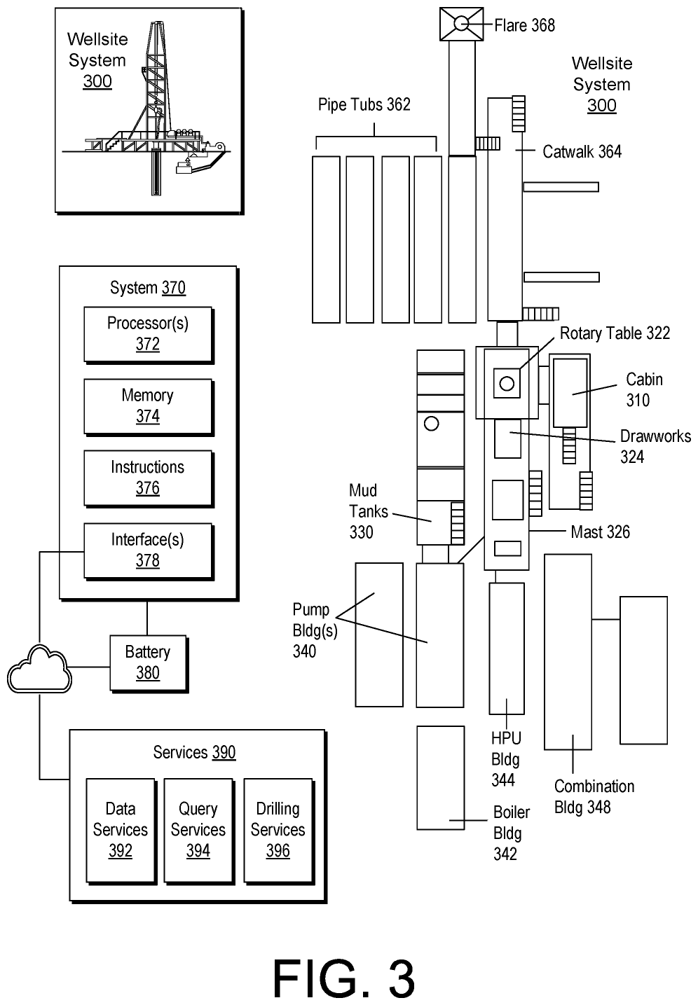

FIG. 3 shows an example of a wellsite system 300, specifically, FIG. 3 shows the wellsite system 300 in an approximate side view and an approximate plan view along with a block diagram of a system 370.

In the example of FIG. 3, the wellsite system 300 can include a cabin 310, a rotary table 322, drawworks 324, a mast 326 (e.g., optionally carrying a top drive, etc.), mud tanks 330 (e.g., with one or more pumps, one or more shakers, etc.), one or more pump buildings 340, a boiler building 342, an HPU building 344 (e.g., with a rig fuel tank, etc.), a combination building 348 (e.g., with one or more generators, etc.), pipe tubs 362, a catwalk 364, a flare 368, etc. Such equipment can include one or more associated functions and/or one or more associated operational risks, which may be risks as to time, resources, and/or humans.

As shown in the example of FIG. 3, the wellsite system 300 can include a system 370 that includes one or more processors 372, memory 374 operatively coupled to at least one of the one or more processors 372, instructions 376 that can be, for example, stored in the memory 374, and one or more interfaces 378. As an example, the system 370 can include one or more processor-readable media that include processor-executable instructions executable by at least one of the one or more processors 372 to cause the system 370 to control one or more aspects of the wellsite system 300. In such an example, the memory 374 can be or include the one or more processor-readable media where the processor-executable instructions can be or include instructions. As an example, a processor-readable medium can be a computer-readable storage medium that is not a signal and that is not a carrier wave (e.g., consider a storage medium that is a storage device).

FIG. 3 also shows a battery 380 that may be operatively coupled to the system 370, for example, to power the system 370. As an example, the battery 380 may be a back-up battery that operates when another power supply is unavailable for powering the system 370. As an example, the battery 380 may be operatively coupled to a network, which may be a cloud network. As an example, the battery 380 can include smart battery circuitry and may be operatively coupled to one or more pieces of equipment via a SMBus or other type of bus.

In the example of FIG. 3, services 390 are shown as being available, for example, via a cloud platform. Such services can include data services 392, query services 394 and drilling services 396. As an example, a service may provide for control of hydrates. For example, consider control of hydrates for reduced hydrate formation or, for example, control of hydrates for improved carbon dioxide sequestration, methane production, etc.

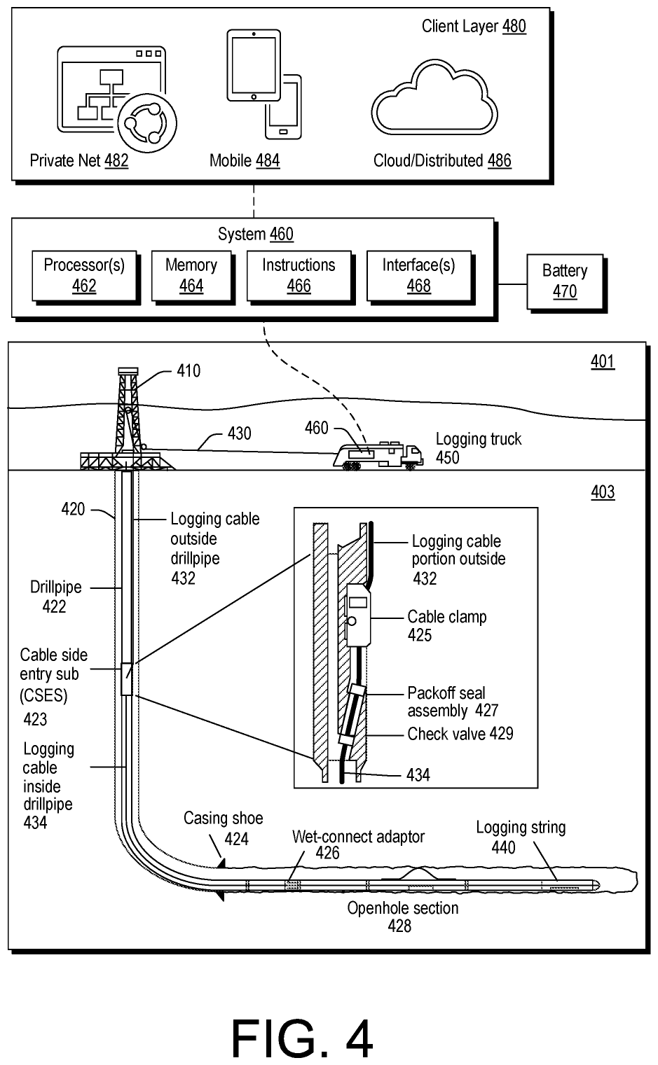

FIG. 4 shows an example of an environment 401 that includes a subterranean portion 403 where a rig 410 is positioned at a surface location above a bore 420. In the example of FIG. 4, various wirelines services equipment can be operated to perform one or more wirelines services including, for example, acquisition of data from one or more positions within the bore 420.

In the example of FIG. 4, the bore 420 includes drillpipe 422, a cable side entry sub (CSES) 423, a casing shoe 424, a wet-connector adaptor 426, and an openhole section 428. As an example, the bore 420 can be a vertical bore or a deviated bore where one or more portions of the bore may be vertical and one or more portions of the bore may be deviated, including substantially horizontal.

In the example of FIG. 4, the CSES 423 includes a cable clamp 425, a packoff seal assembly 427, and a check valve 429. These components can provide for insertion of a logging cable 430 that includes a portion 432 that runs outside the drillpipe 422 to be inserted into the drillpipe 422 such that at least a portion 434 of the logging cable runs inside the drillpipe 422. In the example of FIG. 4, the logging cable 430 runs past the wet-connect adaptor 426 and into the openhole section 428 to a logging string 440.

As shown in the example of FIG. 4, a logging truck 450 (e.g., a wirelines services vehicle) can deploy the wireline 430 under control of a system 460. As shown in the example of FIG. 4, the system 460 can include one or more processors 462, memory 464 operatively coupled to at least one of the one or more processors 462, instructions 466 that can be, for example, stored in the memory 464, and one or more interfaces 468. As an example, the system 460 can include one or more processor-readable media that include processor-executable instructions executable by at least one of the one or more processors 462 to cause the system 460 to control one or more aspects of equipment of the logging string 440 and/or the logging truck 450. In such an example, the memory 464 can be or include the one or more processor-readable media where the processor-executable instructions can be or include instructions. As an example, a processor-readable medium can be a computer-readable storage medium that is not a signal and that is not a carrier wave.

FIG. 4 also shows a battery 470 that may be operatively coupled to the system 460, for example, to power the system 460. As an example, the battery 470 may be a back-up battery that operates when another power supply is unavailable for powering the system 460 (e.g., via a generator of the wirelines truck 450, a separate generator, a power line, etc.). As an example, the battery 470 may be operatively coupled to a network, which may be a cloud network. As an example, the battery 470 can include smart battery circuitry and may be operatively coupled to one or more pieces of equipment via a SMBus or other type of bus.

As an example, the system 460 can be operatively coupled to a client layer 480. In the example of FIG. 4, the client layer 480 can include features that allow for access and interactions via one or more private networks 482, one or more mobile platforms and/or mobile networks 484 and via the “cloud” 486, which may be considered to include distributed equipment that forms a network such as a network of networks. As an example, the system 460 can include circuitry to establish a plurality of connections (e.g., sessions). As an example, connections may be via one or more types of networks. As an example, connections may be client-server types of connections where the system 460 operates as a server in a client-server architecture. For example, clients may log-in to the system 460 where multiple clients may be handled, optionally simultaneously.

FIG. 1, FIG. 2, FIG. 3, and FIG. 4 show various examples of equipment in various examples of environments. As an example, one or more workflows may be implemented to perform operations using equipment in one or more environments. As an example, a workflow may aim to understand an environment, for example, to understand physical phenomena in the environment, structural features in the environment, locations of hydrocarbons, etc. As an example, a workflow may aim to drill into an environment, for example, to form a bore defined by surrounding earth (e.g., rock, fluids, etc.). As an example, a workflow may aim to support a bore, for example, via casing. As an example, a workflow may aim to fracture an environment, for example, via injection of fluid. As an example, a workflow may aim to produce fluids from an environment via a bore. As an example, a workflow may utilize one or more frameworks that operate at least in part via a computer (e.g., a computing device, a computing system, etc.).

The aforementioned PIPESIM framework may be utilized for simulation of single and/or multiphase flow. Such a framework may be implemented in one or more types of workflows such as a workflow for system design, a workflow for production operations, etc. The PIPESIM framework may be utilized to identify situations that demand more detailed simulation, for example, using the OLGA multiphase flow simulator. In various instances, a simulation may be a steady-state simulation or a transient simulation (e.g., with or without one or more steady-states, etc.). As to some examples of transient scenarios, consider one or more of shut-in, startup, ramp-up, terrain-induced slugging, severe slugging, slug tracking, hydrate kinetics and wellbore cleanup. As an example, a workflow can include implementing the PIPESIM framework and one or more instances of an OLGA simulator. As an example, a method may include characterizing fluid behavior using one or more models (e.g., black-oil models, compositional fluid models, etc.).

As to flow assurance workflows, consider tasks such as pipeline and facility sizing. As an example, a workflow may aim to size pipelines to minimize backpressure while maintaining stable flow within a maximum allowable operating pressure (MAOP). As an example, a workflow may aim to size pumps, compressors, and multiphase boosters to meet target rates. As an example, a workflow may provide for assessment of system-design layout options and operating parameters for a range of inputs. As an example, a workflow may provide for sizing separation equipment and slug catchers to manage liquids associated with pigging, ramp-up surges, and hydrodynamic slugging volumes. As an example, a workflow may aim to aid design and/or optimization of one or more pipelines and equipment such as pumps, compressors, and multiphase boosters to maximize production and capital investment. As an example, a workflow may include calculating one or more burial depths and/or insulation types, thicknesses, etc., for pipelines.

As to well performance, a workflow may include performing nodal analysis and diagnosing liquid loading or lift requirements. In various scenarios, artificial lift may be considered where a workflow may assess viability of an artificial lift strategy, equipment, etc. A workflow may provide for design of one or more artificial lift systems (e.g., rod pumps, progressing cavity pumps, ESPs, and gas lift) and compare their relative benefits. A workflow may include assessing production through intelligent completions, for example, by modeling downhole flow control valves and/or other downhole equipment, such as, for example, chokes, subsurface safety valves, separators, and chemical injectors. As an example, a workflow may aid in assessing completion design, for example, by considering skin effects on horizontal well length and tubing and/or casing size. In various scenarios, a workflow may provide for modeling multilaterals and/or wells with multiple layers and crossflow.

As to liquids managements, a workflow may provide for one or more of identification of risk for severe riser slugging, accounting for emulsion formation, assessing operational risk from deposition of wax along flowlines over time, etc.

As to integrity, a workflow may aim to identify locations prone to corrosion and/or predict CO₂ corrosion rates (e.g., or other corrosion rates). As an example, a workflow may utilize one or more American Petroleum Institute (API) techniques, Salama techniques, etc., for example, as to erosion.

As to solids management, a workflow may include identifying risks of potential solids formation including wax, hydrates, asphaltenes, and scales, assessing risk from deposition of wax along flowlines over time. As an example, a workflow can include determining an amount of methanol to inject to avoid hydrate formation.

As an example, a system may utilize one or more frameworks. For example, consider a system that may utilize a reservoir simulator framework (e.g., ECLIPSE, INTERSECT, etc.) and a network framework (e.g., PIPESIM, etc.). As an example, a system may utilize one or more machine learning (ML) models that can be integrated with one or more frameworks (e.g., simulation frameworks, etc.). As an example, a ML model may provide for identification, prediction, etc. For example, consider prediction of properties that may then be utilized by a framework for simulation, etc. As to identification, consider an identification process where a region or regions can be identified as to properties that may be suitable for one or more operations where such operations may be simulated using a framework or frameworks.

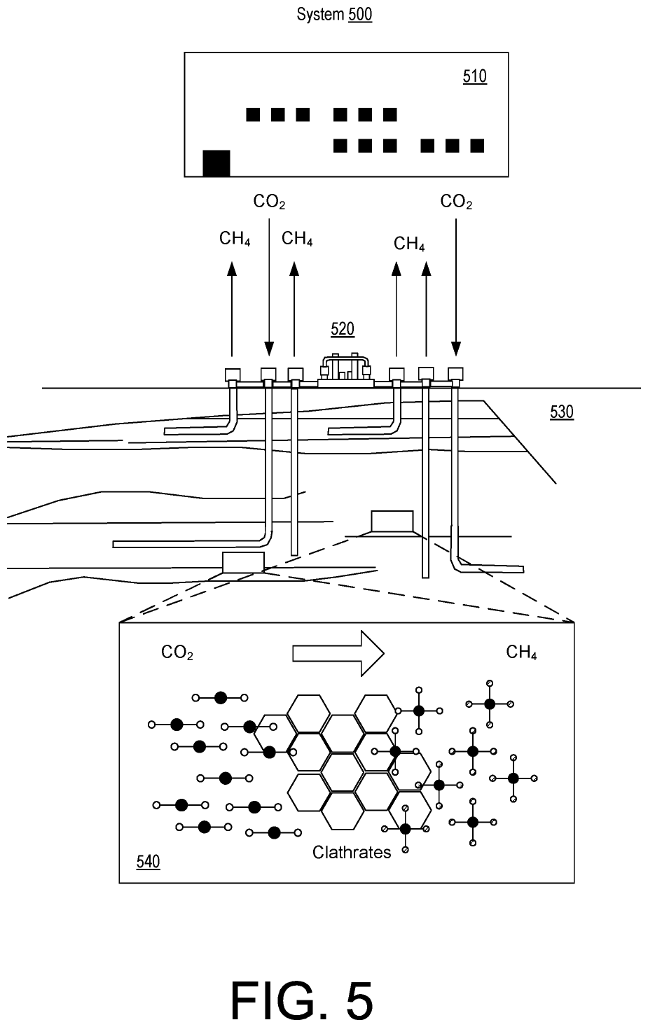

FIG. 5 shows an example of a system 500 that includes a facility 510 that can produce CO₂ and consume methane (CH₄), equipment 520 with conduits extending into a subsurface region 530 and various processes 540 where, for example, CO₂ can be sequestered as methane is released. In particular, the subsurface region 530 can include clathrates and/or clathrate forming materials that can provide spaces to hold CO₂ and/or CH₄.

As mentioned, clathrate hydrates represent a class of solid state materials. Clathrate hydrates exist in oceans and permafrost regions and exhibit an ability to trap atoms and small molecules (e.g., methane and other small hydrocarbons). Where hydrocarbons are trapped, clathrate hydrates can serve as an energy source. In the oil and gas industry, solid methane clathrate hydrate can plug natural gas pipelines and disrupt oil drilling processes.

As an example, clathrate hydrates may be utilized to store hydrogen and/or sequester carbon dioxide. Trapping of carbon dioxide molecules in clathrate hydrates may be a controllable process that can provide a way to reduce CO₂ levels in gas. As an example, clathrate hydrates may be utilized in separation of gases such as CO₂ from gas (e.g., flue gases, desalination, etc.). For example, clathrate hydrates may be used in flue gases to separate CO₂ by encouraging the formation of CO₂ clathrate hydrate in a flue gas mixture. As to hydrate-based desalination, a process can commence when clathrate hydrate forming agent is injected into seawater that has a surrounding temperature lower than clathrate hydrate forming temperature where such a condition promotes solidification and condensation of water molecules around the hydrate formers such that a slurry of clathrate ice and brine form. Once formed, brine can be separated from the slurry of clathrate ice and the clathrate melted via heat exchange with warmer surface water of the ocean.

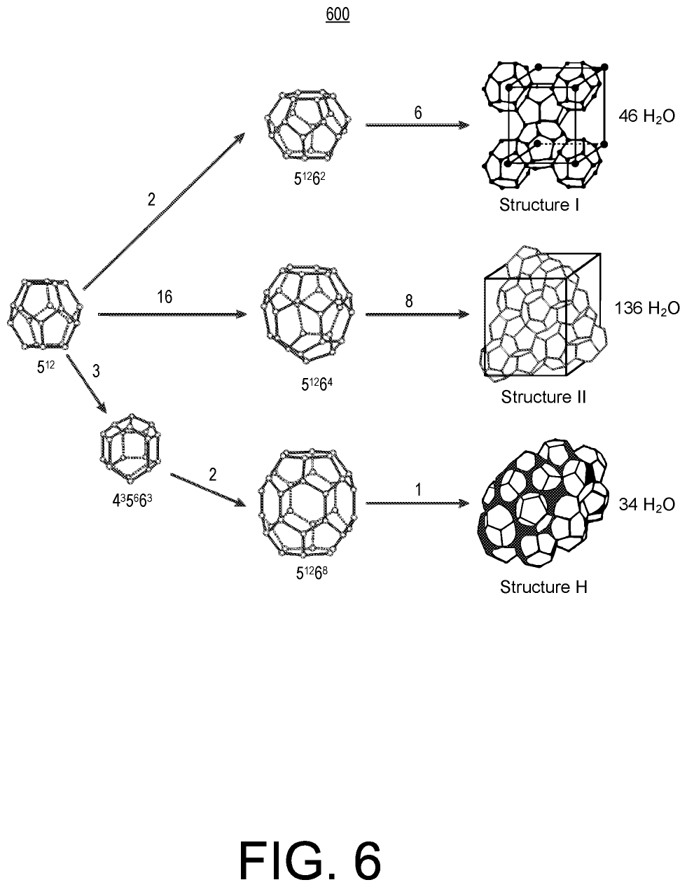

FIG. 6 shows example graphics 600 of clathrate hydrate structures (Structure I (sl), Structure II (sll) and Structure H (sH)). Clathrate hydrates are nonstoichiometric, solid lattice inclusion compounds with a crystalline water cage that enclathrates small gas molecules. Generally, there are vacant cages in the clathrate hydrates, but a sufficient number of gas molecules can typically be present inside the cages to stabilize the structure. As an example, a structure may include one molecule per cage. However, in a high pressure environment (e.g., >0.1 GPa), a cage may include more than one gas molecule. Clathrates can have physical properties akin to water, for example, consider one or more of physical appearance, refractive index, and density. However, they can also differ from water when considering properties like mechanical strength, heat capacity, thermal conductivity.

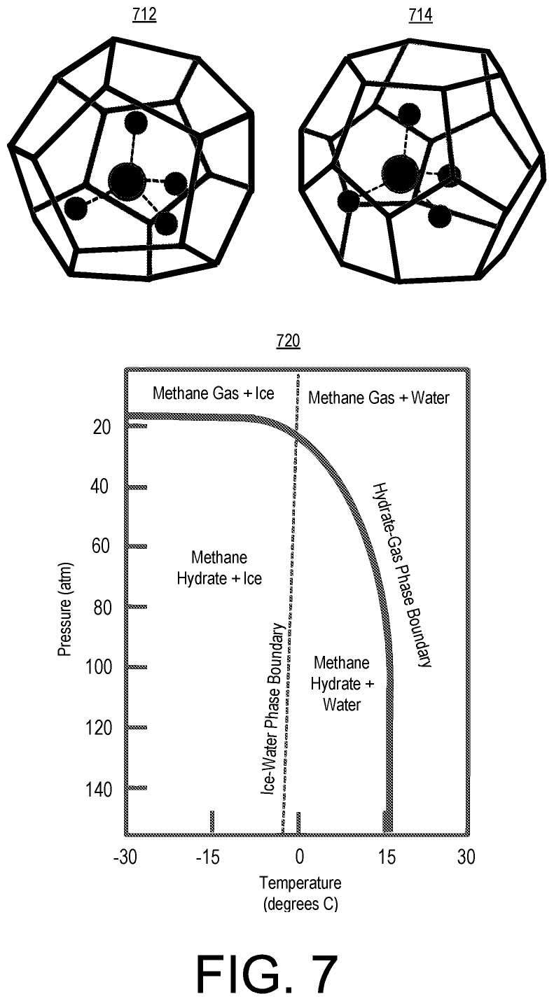

FIG. 7 shows examples of structures of clathrates 712 and 714 along with a phase diagram 720. As explained, clathrate structures can differ. In FIG. 7, the structure 712 is a dodecahedral structure (Structure I (sl)) with a methane guest molecule and the structure 714 is a tetradecahedral structure (Structure I (sl)) with a methane guest molecule. As to the phase diagram, as indicated, pressure and temperature can determine phase in a methane, water system where a hydrate-gas phase boundary may be discerned. As an example, one or more operations may be performed using phase information. As an example, one or more regions may be identified using information as to pressure and temperature, along with water and/or methane concentrations, distributions, etc. In the phase diagram 720, phases shown include a methane hydrate and ice phase, a methane gas and ice phase, a methane hydrate and water phase and a methane gas and water phase. The phase diagram 720 includes an ice-water phase boundary together with a hydrate-gas phase boundary. As to the latter, it generally exists at temperatures less than approximately 20 degrees C. and pressures greater than approximately 10 atm (e.g., approximately 1 MPa).

In a geologic environment, conditions may change due to one or more drivers. For example, consider flow of fluid, which may be due to one or more production and/or injection techniques. For example, consider injection of a first gas into a formation that includes hydrates that include a second gas. In such an example, the first gas may displace the second gas where properties of the first gas and the formation may determine a rate of exchange and/or stability of the hydrates. As another example, consider injection of gas into a formation where properties of the gas may be amenable to hydrate formation in the formation to sequester the gas. As explained, various types of schemes, workflows, etc., may be performed with respect to a formation that can include hydrates, provide conditions for formation of hydrates, etc.

Referring again to the example graphics 600 of FIG. 6, from X-ray diffraction studies, various types of structures have been determined, including Structure I (sl), Structure II (sll), and Structure H (sH). The sl structure is a body-centered cubic structure and has two cage types: a small pentagonal dodecahedral cage (5¹²) and a large tetrakaidecahedral cage (5¹²6²). The structure sll is a diamond lattice within a cubic framework and has two cage types: small cage (5¹²) and a large hexacaidecahedral cage (5¹²6⁴). The sll structure fits molecules in natural gases or oils that are larger than ethane but smaller than pentane. The sl and sll structures are of interest for gas companies because they form when natural gas molecules interact with water near gas pipelines or deep ocean areas. The sH structure has a hexagonal framework and three cage types: a small 5¹² cage, a mid-sized 4³5⁶6³ cage, a large icosahedral cage 5¹²6⁸.

The sH hydrate structure is able to fit larger molecules contained in crude oils. The cage size may be determined by size of the largest guest molecule. For example, methane can fit into both small and large cages of sl; whereas, other large hydrocarbon molecules such as propane tend to be too large to fit into the large cage of sl. However, they can fit into the larger cages of sll. Clathrate hydrates formed near oil and gas pipelines tend to be of the sll structure as they can include larger hydrocarbon molecules such as, for example, propane and isobutane. Spectroscopy has been used to analyze guest occupancy and found that molecules below 0.35 nm tend to not stabilize sl and that molecules above 0.75 nm tend to not stabilize sll. When a large organic molecule is combined with a clathrate hydrate promoter, it is possible to form hydrates with atypical crystal structures. New structures are being discovered as researchers produce clathrate hydrates with different types of gases.

As an example, density functional theory (DFT) may be utilized for modeling structural, dynamical, thermodynamic, and spectroscopic properties of clathrate hydrates. For example, interaction energies, free energies, and reactive energies of clathrate cages may be determined using DFT. As an example, one or more simulations based upon statistical mechanics may be utilized such as, for example, classical DFT and Monte Carlo (MC) methods. For example, a simple lattice gas approximation with classical DFT coupled with Platteeuw theory may be utilized to model clathrate hydrate phase equilibria for hydrate guest molecules. Standard DFT calculations may be used to probe structure, stability and reactivity of H₂ clathrates. Using B3LYP Huzlll-su3 DFT, NMR parameters may be computed (¹³C and ¹H shielding constants and spin-spin coupling constants for 5¹², 5¹²6², and 5¹²6⁴ cages hosting methane, ethane, and propane guests). As an example, ab initio molecular dynamics (AIMD) via atom-centered density matrix propagation (ADMP) methodologies may be used to study time-dependent structural behavior of noble gas hydrates on the timescale of ˜500 fs. DFT may be utilized in combination with the M06-2X method to determine relative stabilities of guest species in various clathrate hydrate host sites. Such an approach has been used to predict that the guest molecules N₂ and NO are more stable in a 5¹²6⁴ cage and that the SI NO hydrate is less stable than the SII NO hydrate. For the guest N₂, the type II hydrate structure with single occupancy provides more stability than a type I structure with multiple occupancy. DFT may be utilized to predict severe deformations when CS₂ is enclathrated in 5¹² and 5¹²6² cages. The 5¹², 5¹²6², and 5¹²6⁴, cages can enclathrate up to 2 N₂ molecules; noting that two H₂S molecules can be enclathrated in a 5¹²6⁴ cage. DFT modeling and other types of modeling involving halogen guests in clathrate hydrate hosts may be performed.

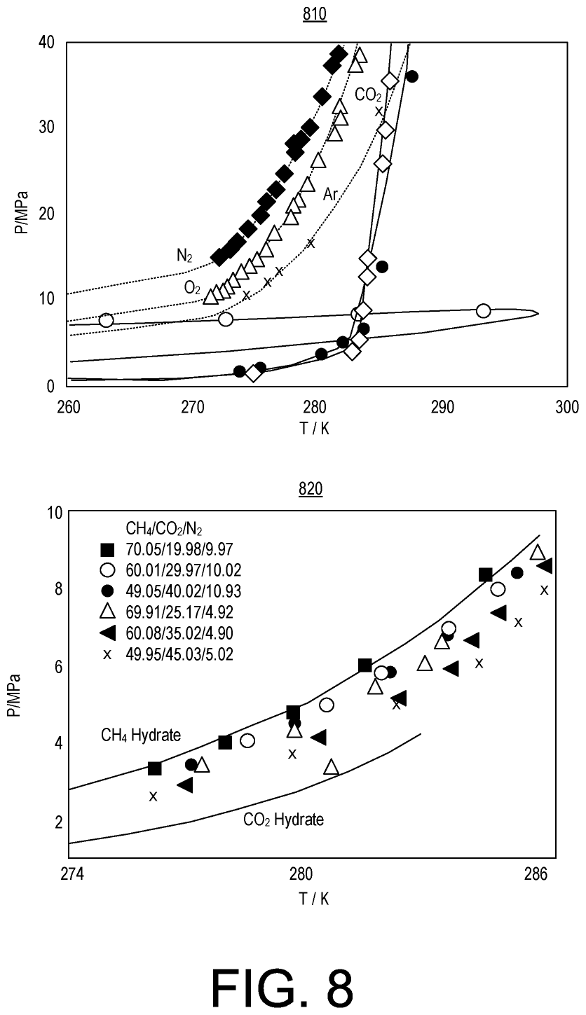

FIG. 8 shows example plots 810 and 820 of pressure versus temperature for various compositions, including CH₄ hydrate and CO₂ hydrate. The data include various examples that include CH₄, CO₂ and N₂ (e.g., from 49.05 to 70.05 CH₄, from 19.98 to 45.03 CO₂ and from 4.9 to 10.93 N₂). Such plots can provide information as to transitions between CO₂ hydrate and CH₄ hydrate. For example, consider a process that aims to displace and liberate CH₄ with CO₂. In such an example, the CH₄ may be utilized as an energy source where combustion with oxygen can generate CO₂ where the CO₂ may be stored in hydrate form. The example plots 810 and 820 may be utilized in combination with other data such as, for example, the data of the pressure versus temperature plot 720 of FIG. 7.

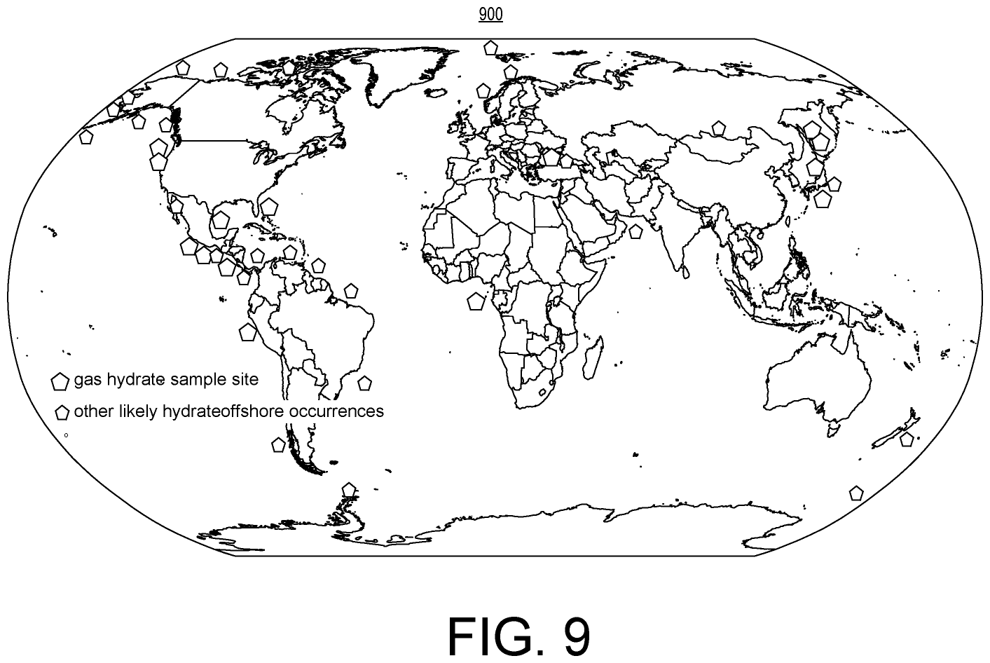

FIG. 9 shows a graphical user interface (GUI) 900 that includes a map with marked locations as to gas hydrate sample sites and other likely hydrate offshore occurrences. As an example, a method may aim to identify one or more sites that include hydrates, etc. For example, consider identification of a site or sites that can be amenable to a process or processes for liberation of methane and/or storage of carbon dioxide. In the map of the GUI 900, information may be incomplete. For example, other regions can exist that may include and/or be suitable for hydrates. As explained, a method can include identifying one or more regions that can include and/or can form hydrates.

As mentioned, a reservoir simulator may be utilized to assess a region with respect to hydrates where, for example, the reservoir simulator may include capabilities for handling hydrates (e.g., prediction of formation, dissipation, exchange of constituents, etc.). Where a workflow aims to assess a relatively large number of formations, simulator efficiency can be beneficial, where an efficient simulator can greatly reduce demands on time and computational resources.

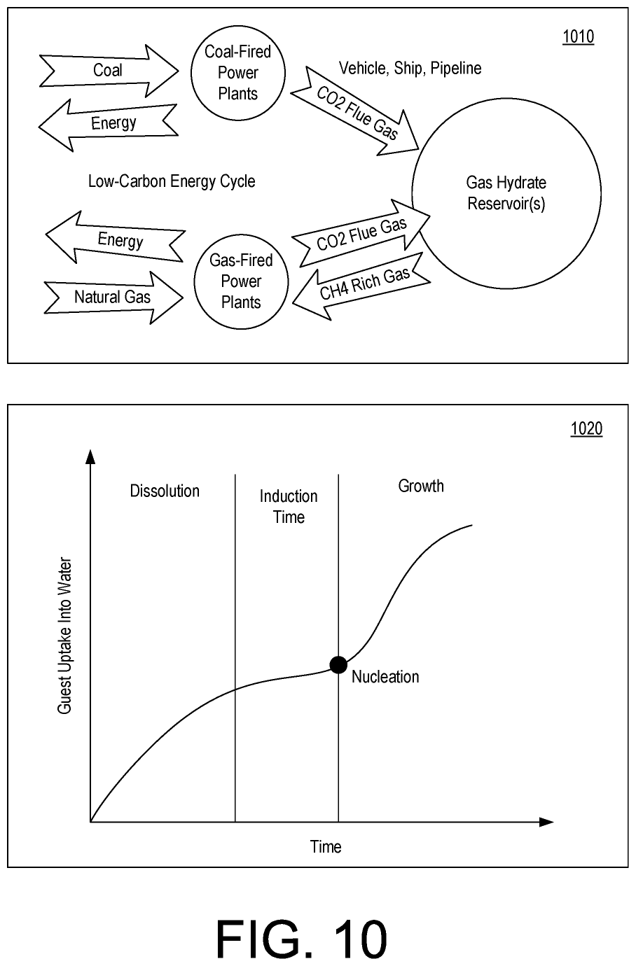

FIG. 10 shows an example graphic 1010 and an example plot 1020 as to various processes, including liberation of methane from a gas hydrate reservoir and storage of carbon dioxide in a gas hydrate reservoir. The plot 1020 illustrates a guest uptake into water process with respect to time where various times can correspond to dissolution, induction, nucleation, and growth. Each of such processes can be characterized by one or more rates, which can depend on various factors. For a process illustrated in the graphic 1010 to be planned, performed, controlled, etc., an understanding of dissolution, induction, nucleation, and growth can be helpful, for example, from left to right (e.g., a forward process) as shown in the plot 1020 and/or from right to left (e.g., a reverse process).

As an example, a method can provide a pragmatic way to investigate how to store CO₂ in a hydrates state while producing CH₄. In such an example, one or more tools for exploring or determining aspects of pressure and temperature ranges (see, e.g., the plots of FIG. 7 and FIG. 8), kinetics, types of hydrates, reversibility, mechanical stability, mechanical stress and/or strain, etc. can be useful. For example, a system can include one or more components that can provide for consideration of such factors in simulating an environment for purposes of storage and/or liberation of methane and/or carbon dioxide.

As an example, a system can utilize a wide range of experimental data, which can include laboratory data, data from known hydrates reservoirs. Such a system may utilize one or more kinetic relationships, kinetic data, etc., for example, as to one or more CO₂/CH₄ swapping mechanisms. Such a system may utilize information as to dissolution, induction, nucleation, growth, etc., which may be modeled or otherwise described as reactions. As an example, a system may consider hydrate self-preservation effects, ionic exchange shifting of equilibrium, various pressure, and/or temperature ranges, etc. As an example, a system can include one or more machine models such as one or more machine learning models. For example, consider a system that can generate a trained machine learning model (ML model) and utilize such a trained ML model for one or more purposes. As an example, a trained ML model or trained ML models may be operatively coupled to one or more simulators such that a simulator can perform time-based simulations as to one or more hydrate related processes (e.g., carbon dioxide storage, methane liberation, geomechanical changes, etc.).

As an example, a system may utilize data such as the Ignik Sikumi data of the USGS/DOE. The DOE performed field testing of the Ignik Sikumi gas hydrate production test well project on the North Slope of Alaska in 2012. The test aimed to investigate a production method in which carbon dioxide injected into a gas hydrate-bearing rock unit can release methane while sequestering carbon dioxide in hydrate form. The Ignik Sikumi test featured the injection of a mixture of carbon dioxide and nitrogen over a 12 day period and the well was then backflowed in a depressurization mode for 21 additional days. In the study, methane was produced immediately at the start of the backflow period, increasing in abundance for two days, and then the produced-gas composition stabilized. Carbon dioxide and nitrogen abundance dropped from injection percentages at initial backflow to relatively low percentages in less than two days. In the later part of the depressurization phase of the project, the well was operated at pressures below the equilibrium conditions for methane hydrate. The USGS supported the Ignik Sikumi test with detailed geologic and geophysical studies of the sites considered, for which data are available. The USGS also participated in downhole logging, formation testing, and well geochemical sampling. Additionally, the USGS analyzed gas and water samples collected from the well production stream to determine effectiveness of the carbon dioxide and methane exchange process.

While some process data exist, such as from the Ignik Sikumi test, various aspects of hydrates in-situ are not understood and have not been modeled. As an example, one or more ML modeling approach can be applied to data to generate one or more trained ML models. In such an example, one or more simulators may be operatively coupled to one or more trained ML models or otherwise integrated therewith. Such an approach can facilitate planning, development, operation and control of hydrate related processes, for example, on an industrial scale.

As an example, a system may provide for hydrate reservoir simulation, for example, with one or more injection wells and/or one or more production wells. In such an example, various physical processes may be simulated such as, for example, one or more of thermal effects due to hydrates formation and disassociation, hydrates generation changing effective permeability, porosity, etc., swapping/dissociation mechanism(s), etc.

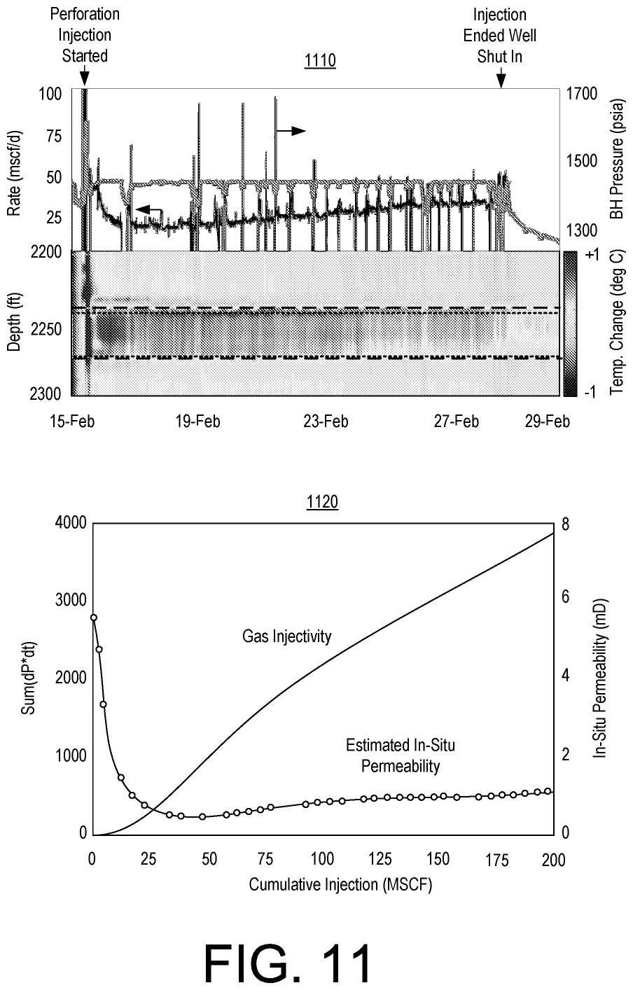

FIG. 11 shows example plots 1110 and 1120 of data from the Ignik Sikumi site where injection was utilized. As to the plot 1110, it shows pressure, gas injection rate, and temperature (DTS) during injection where thick dashed lines indicate the targeted formation and the small dashed lines indicate the perforated zone. In the plot 1110, warming during injection may signal an exothermic reaction that accompanied hydrate formation or exchange with native methane hydrate. Also, in the plot 1110, a cooling event occurred above the perforated interval (2230 ft to 2245 ft) and continued in this restricted interval for some time following perforation.

In FIG. 11, the plot 1120 is a Hall plot of injection performance compared with aquifer models that assumed estimated in-situ permeability during an injection phase. As shown in the plot 1120, in-situ permeability in mD tended to initially decrease and then increase with respect to cumulative injection. As an example, tests, simulations, etc., may be performed to provide data such as data in the plots 1110 and 1120 that can be indicative of physical processes in a reservoir, which can impact factors such as permeability.

As an example, a reservoir simulator can utilize underlying processes, as may be based on output of one or more ML models, to generate simulation results for storage and/or liberation of carbon dioxide and/or methane. As explained, composition in a liquid phase, composition in a gas phase, etc., may be modeled and/or simulated where composition changes may be related to reservoir dynamics (e.g., flow, geomechanics, temperature, pressure, permeability, etc.). As mentioned, a simulator may account for solid phase phenomena such as, for example, formation of a solid phase, reduction of a solid phase, etc. As explained, hydrates are solids and may be accounted for using solid phase modelling.

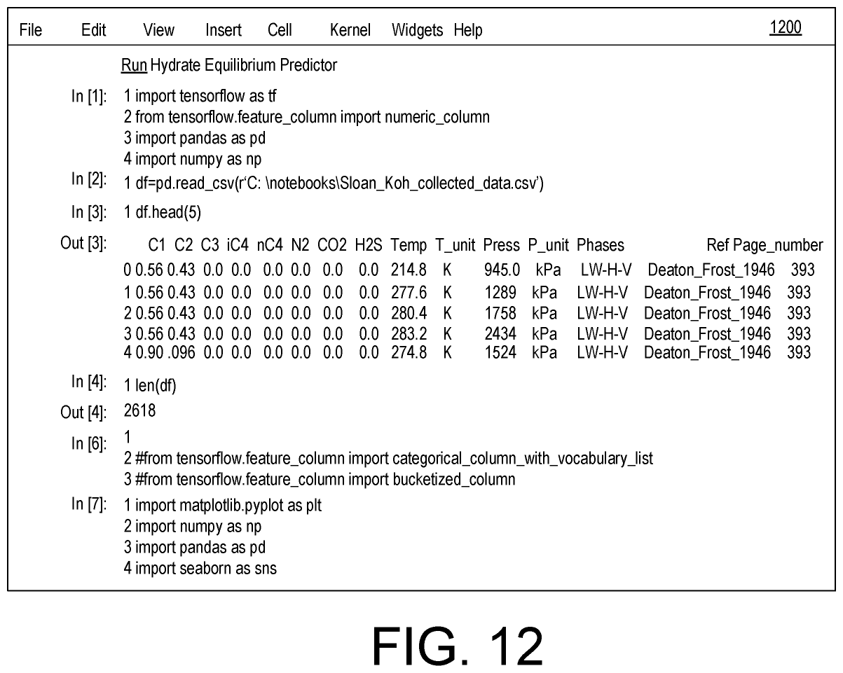

FIG. 12 shows an example of a graphical user interface (GUI) 1200 of a system that provides for prediction of hydrate equilibrium. For example, consider a ML model-based predictor that can be generated using data and a machine learning framework. As shown in the example of FIG. 12, C1, C2, C3, iC4, nC4, N₂, CO₂, H₂S, temperature, pressure, and phases may be taken into account. In the example of FIG. 12, the framework is the TENSORFLOW framework (Google, Mountain View, California), which is an open-source software library for machine learning and artificial intelligence.

In the GUI 1200, various types of data can be accessed from one or more resources, which may be available online, in a database, in a printed article, a digital file, an image file, etc. For example, consider the book by Sloan and Koh, Clathrate Hydrates of Natural Gases, 12th ed., CRC Press, Boca Raton, FL (2007), a report by Deaton and Frost, Gas hydrates and their relation to the operation of natural-gas pipelines, Technical Report BM-Mon-8, Bureau of Mines, US (1946), etc.

As an example, the GUI 1200 can be utilized to generate one or more ML models that can be utilized to predict hydrate equilibrium values such as, for example, equilibrium pressure, equilibrium temperature, etc. For example, the GUI 1200 can access data and call one or more libraries of an ML model framework to train one or more ML models using the data.

As set forth in the GUI 1200, nitrogen can be taken into account. For example, nitrogen may be used as a pre-flush or as a carbon dioxide diluent. Use of a pre-flush or a diluent can help to address one or more issues associated with carbon dioxide injection, which may change phase at bottomhole pressures and temperatures (e.g., consider a change from gas to liquid). Also, excess carbon dioxide can interact with excess formation water to form additional hydrate saturation that can reduce permeability.

As an example, a system may be extensible to account for one or more factors and, for example, to utilize data that may become available and/or otherwise accessible. In such an example, the GUI 1200 may be extensible in an automated manner and/or a user interactive manner such that one or more ML models can be generated responsive to one or more factors of interest for a formation and/or responsive to availability and/or accessibility of data.

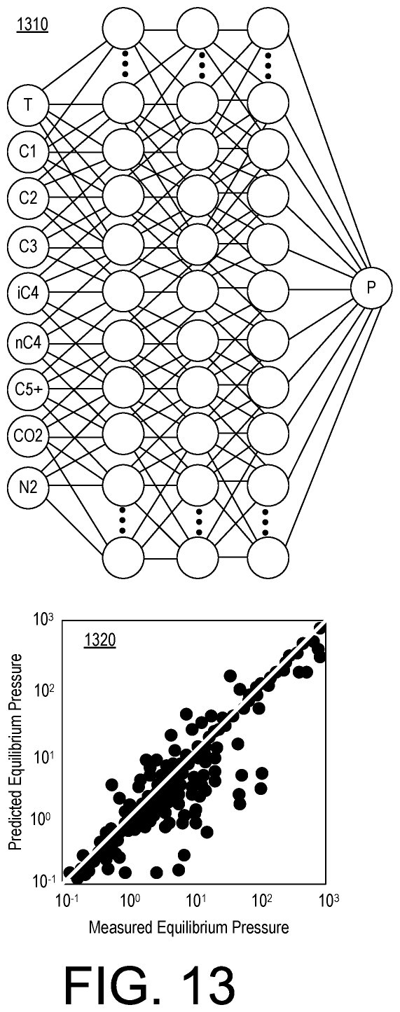

FIG. 13 shows an example of a machine learning model architecture 1310 with various inputs and layers, which can provide one or more outputs (e.g., prediction or predictions, etc.), and an example plot 1320 of a comparison between predicted equilibrium pressure and measured equilibrium pressure. As shown, an acceptable relationship exists over a range of equilibrium pressures. As an example, such a trained ML model may be utilized in combination with one or more simulators (e.g., reservoir simulators, etc.). In such an approach, a simulation may be expedited as various complex relationships can be represented by one or more trained ML models that can provide for rapid output given simulation conditions. As an example, a ML model can provide for outputting hydrate information germane to hydrate composition, temperature, and/or pressure. For example, consider hydrate information that includes hydrate equilibrium pressure. As an example, hydrate information may provide for solid phase determinations (e.g., how much of a solid phase exists in a cell of a reservoir model). For example, predicted hydrate equilibrium pressures can allow for hydrate solid phase determinations in spatially distributed, volumetric cells of a reservoir simulation model. As explained, a reservoir simulator can include features for handling gas, liquid, and solid phases. As to phase determinations, consider a gas equilibrium pressure that is defined as the pressure exerted by a vapor (gas) in thermodynamic equilibrium with one or more of its condensed phases (solid or liquid) at a given temperature in a closed system. For hydrates, they can form when an appropriate guest molecule and water are present at temperature and pressure conditions facilitating hydrate formation. Hence, predicted hydrate equilibrium pressure values for cells of a reservoir simulation model can be utilized in determining where hydrates can form, in what amounts they form, and which type or types are formed (e.g., and/or dissolved, and/or transformed from one type to another, etc.). Referring again to the plot 820 of FIG. 8, as shown, for a given temperature, CH₂ hydrate or CO₂ hydrate may exist, depending on pressure (e.g., and amounts of CH₂, CO₂ and N₂). A reservoir simulator operatively coupled to an ML model that can predict hydrate equilibrium pressure can provide for making determinations as to hydrates that can depend on compositions and conditions in individual cells of a reservoir simulation model. Where a reservoir simulator simulates phenomena with respect to time, hydrate dynamics may be determined (e.g., formation, dissolution, transition from one type to another type, etc.).

In the example ML model architecture 1310, the inputs for molecular components may be specified, for example, as mole fraction (e.g., or mole percent). For example, consider the GUI 1200 of FIG. 12 where C1 is specified as 0.56 and C2 as 0.43 in various entries and 0.90 and 0.096 in another entry. As shown, pressure may be specified in kPa (see, e.g., range from 945 kPa to 2434 kPa in the examples of the GUI 1200) and temperature may be specified in degrees K (see, e.g., range from 214.8 K to 283.2 K). Thus, experimental data may be accessed for a range of compositions, pressures, and temperatures. As explained, in various examples nitrogen may be relevant, for example, as a component injected in combination with carbon dioxide (e.g., or flue gas, etc.). Thus, experimental data that includes nitrogen can be utilized to train a ML model. As an example, experimental data may include data that accounts for various hydrate formers (e.g., methane, ethane, propane, iso-butane, n-butane, carbon dioxide, nitrogen, and hydrogen sulfide).

In the example plot 1320, the predicted equilibrium pressure is given over a range from approximately 0.1 to 1,000 (e.g., four orders of magnitude) using a ML model that was trained on over 2000 experimental data points.

As explained, predictions of hydrate formation conditions made using a phase equilibria flash or Gibbs free-energy package that relies on a hydrate equation of state (EOS) can be demand considerable time and resources, which can make a study that relies on multiple simulations impractical.

As an example, one or more ML models may utilize variables such as one or more of temperature, pressure, composition (liquid, gas), type of impurities, and amount of water. Such an approach can provide for concentration predictions, liberation predictions, amount of impurities, etc. In combination with simulation, such an approach may provide results as to operational scenarios that can be feasible and implemented in the real world. As an example, a system may provide for pre-processing of one or more materials. For example, consider pre-processing of a CO₂ stream such that it can be injected into a reservoir for storage, which may also act to liberate CH₄. As an example, a system may provide for field feasibility analysis, for example, to determine whether a particular field can feasibly be utilized.

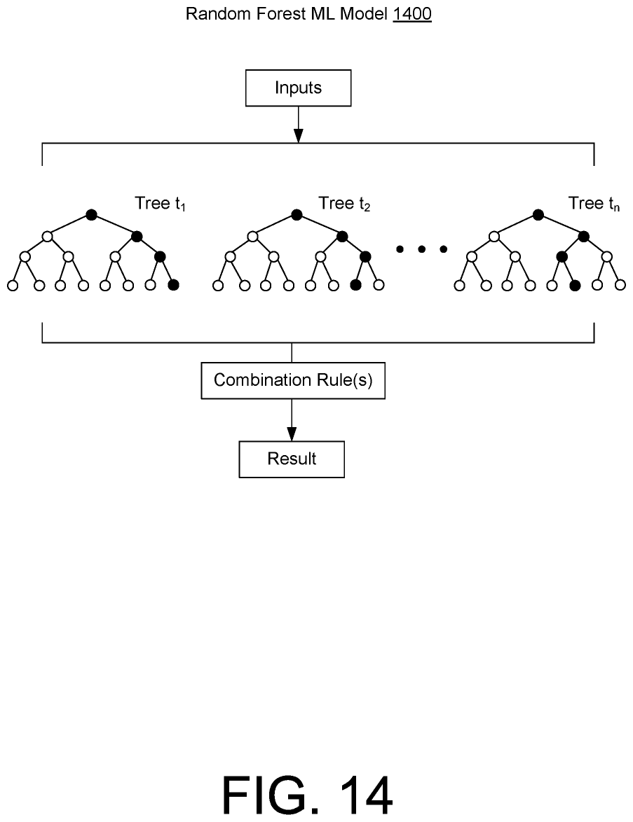

FIG. 14 shows an example of a random forest ML model 1400 that can include inputs, trees labeled t₁ to tₙ, and one or more combination rules to output a result. In the example of FIG. 14, the ML model 1400 can be a regression model or a classification model, for example, depending on the one or more combination rules.

As shown in FIG. 14, inputs can be fed to the trees where each of the trees may, dependent on the combination rule(s), “vote” for a class in a classification scheme to determine vote count as to a class as a result or where a decision as a value from each of the trees may be combined to determine an ultimate value as a result in a regression scheme. As to combining values, averaging may be utilized, which may be output along with one or more statistical metrics (e.g., standard deviation, etc.).

As an example, where tree structures are utilized, a tree can be grown using a number of cases in a training set, N, by sampling N cases randomly, with replacement from the original data. The sample can be a training set for growing a tree. If there are M input variables, a number m«M can be specified such that at each node, m variables are selected at random out of the M and the best split on these m is used to split the node. The value of m can be held constant during the forest growing. As an example, each tree can be grown to a largest extent possible (e.g., without pruning).

Forest error rate can depend on various factors such as, for example, the correlation between two trees in the forest where increasing the correlation increases the forest error rate; and strength of each individual tree in the forest where a tree with a low error rate can be a strong classifier and where increasing the strength of the individual trees decreases the forest error rate.

As an example, reducing m can reduce both the correlation and the strength; whereas, increasing m can increase both. For random forests, somewhere in between is an optimal range of m. Using an out-of-bag (oob) error rate, a value of m in the range can be found, which may be an adjustable parameter to which random forests can be somewhat sensitive.

Features of a random forest can include efficiency on large sets of data, estimates of variables are particularly notable for classification, generation of an internal unbiased estimate of the generalization error as the forest building progresses, effective handling of missing data via estimating missing data (e.g., including maintaining accuracy when a relatively large proportion of data may be missing), an ability to balance error in class population unbalanced data sets, ability to use on other data, understanding of relation between the variables and the classification, computation of proximities between pairs of cases (e.g., for use in clustering, locating outliers, etc.), ability to use scaling to provide various views of data, ability to extended to unlabeled data (e.g., leading to unsupervised clustering, data views and outlier detection), and providing an experimental method for detecting variable interactions. A random forest approach does not over-fit and the number of trees can be many while still maintaining reasonably low computational demands.

As an example, trees can be constructed as follows: i) at each node, a single variable is selected with the m-th variable having probability p (m) of being selected; ii) if the variable is strong, the split is at the midpoint of the of values if the selected variable at the node; and iii) if the variable is weak, the split is at a random point along its values in the node.

As an example, a machine learning method can utilize a nearest neighbor algorithm. As an example, a random forest can be a type of nearest neighbor algorithm, for example, it can be an adaptive nearest neighbor algorithm where i) randomization works to reduce the variance; ii) it adapts to the loss function by having the narrowest widths in the terminal nodes corresponding to the largest components of the loss function; iii) it automatically adapts to the sample size; and iv) the optimal value of mtry does not depend on the sample size (see, e.g., Breiman, Consistency for a Simple Model of Random Forests, Technical Report 670, Statistics Department, University of California at Berkeley (2004), which is incorporated by reference herein in its entirety).

As an example, gradient boosting may be utilized. For example, gradient boosting can be utilized as a machine learning technique for regression and classification problems to generate a prediction model in the form of an ensemble of weak prediction models, which may be in the form of decision trees. Gradient boosting can build a model in a stage-wise fashion and generalize by allowing optimization of an arbitrary differentiable loss function.

In the TENSORFLOW framework, a random forest with hyperparameter tuning may be implemented using one or more statements of the following example pseudo-code:

import tensorflow_decision_forests as tfdf
import pandas as pd
dataset = pd.read_csv(“project/dataset.csv”)
tf_dataset = tfdf.keras.pd_dataframe_to_tf_dataset(dataset,
label=“my_label”)
model = tfdf.keras.RandomForestModel( )
model.fit(tf_dataset)
print(model.summary( ))
#Hyperparameter tuning:
import tensorflow_decision_forests as tfdf
import pandas as pd
dataset = pd.read_csv(“project/dataset.csv”)
tf_dataset = tfdf.keras.pd_dataframe_to_tf_dataset(dataset,
label=“my_label”)
tuner = tfdf.tuner.RandomSearch(num_trials=20)
# Hyperparameters to optimize.
tuner.discret(“max_depth”, [4, 5, 6, 7])
model = tfdf.keras.RandomForestModel(tuner=tuner)
model.fit(tf_dataset)
print(model.summary( ))

As explained, a random forest ML model can be a collection of deep classification and/or regression decision trees (CART) trained independently and without pruning where each tree can be trained on a random subset of the original training dataset (sampled with replacement). For prediction of hydrate equilibrium pressure, a random forest ML model proved to be suitably optimizable for robust performance.

As an example, depending on type of ML model or ML models utilized, a method can include using cross-validation as a statistical technique to estimate skill of one or more ML models. Cross-validation can be used in applied machine learning, for example, to compare and select a model for a given predictive modeling problem because it is easy to understand, easy to implement, and results in skill estimates that generally have a lower bias than other methods. As an example, a k-fold cross-validation procedure can be implemented for estimating skill of one or more ML models.

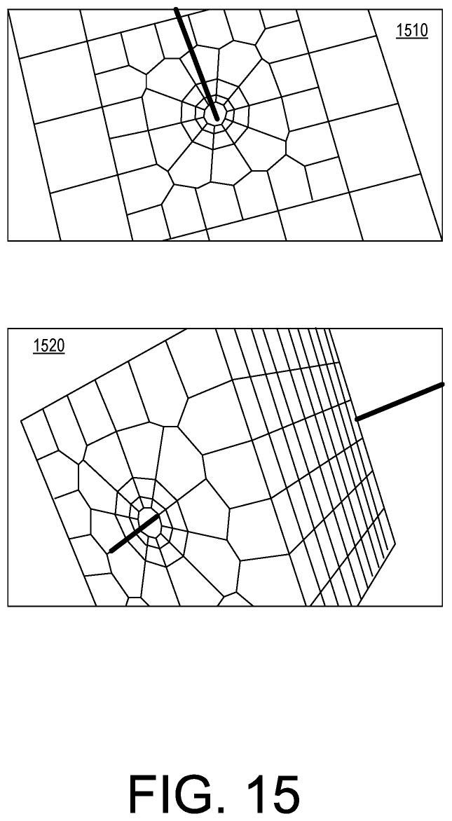

FIG. 15 shows example views 1510 and 1520 of a portion of a reservoir model suitable for performing reservoir simulations. As shown, the reservoir model can include cells (e.g., grid cells) that can model a well (e.g., a well bore, etc.). In such an example, the well may be utilized for injection and/or production of CO₂ and CH₄.

As explained, a cell can be utilized by a numerical technique to discretize equations that govern physical phenomena such as, for example, one or more of fluid dynamics, thermodynamics, geomechanics, etc. As an example, a three-dimensional simulator can implement one or more types of solution schemes, which can include implicit, explicit, a combination of implicit and explicit techniques. For example, consider a scheme that uses both implicit and explicit techniques where pressure is solved for implicitly and concentrations and/or saturations are then solved for explicitly. In such an example, phase saturations and/or concentrations may be solved using a flash package. As explained, where hydrates are to be taken into account, a flash package with hydrate capabilities may be unavailable or too complex or limited. To handle hydrates, a simulator can include or can access a ML model that can predict values germane to hydrates such as, for example, values for hydrate equilibrium pressures. Such a ML model can be integrated into a simulation to provide for robust operation and prediction of values germane to hydrates.

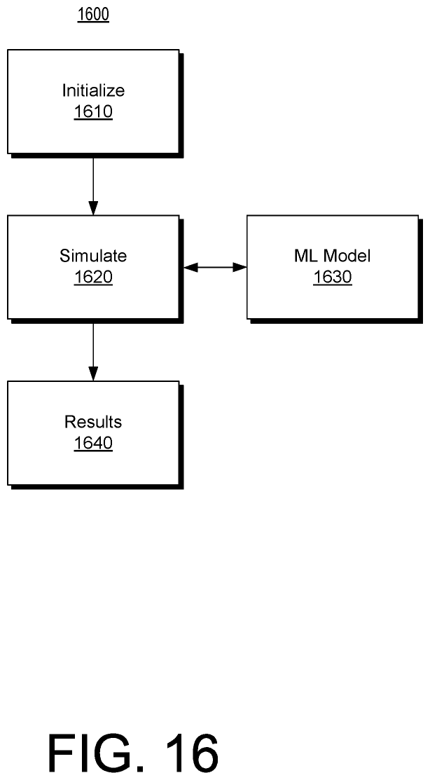

FIG. 16 shows an example of a method 1600 that includes an initialization block 1610 for initializing a simulator, a simulation block 1620 for performing a simulation, a ML model block 1630 for operating a ML model during the simulation, and a results block 1640 for outputting simulation results generated by the simulation. In such an example, the ML model block 1630 can provide for predicting hydrate equilibrium pressure responsive to a call from the simulator of the simulation block 1620. For example, the ML model block 1630 may operate using an application programming interface (API) where the simulator makes an API call that includes input values for the ML model and where the ML model returns one or more predicted values based on the input values. In such an example, the values may correspond to one or more cells of a model of a geologic environment where, the values may be used to determine whether hydrates are formed, dissolved, increased in volume, host-substituted, etc. In such a manner, the simulator can determine spatially, and optionally with respect to time, hydrate presence, absence, behavior, condition, etc. As shown in the examples of FIG. 12, FIG. 13, FIG. 14, etc., inputs can include carbon-related information, temperature information, nitrogen information, hydrogen sulfide information, etc.

As an example, a framework can include accounting for hydrate kinetics as various types of hydrate related processes in a reservoir may be kinetically dominated. As an example, a framework can include accounting for heat transfer. As mentioned, one or more types of hydrate processes can be exothermic such that heat is generated where, for example, carbon dioxide is injected into a formation that includes methane hydrate. As an example, a framework can include a spatially based model where properties germane to hydrates are specified, which can include specifying such properties in a manner that reflects actual reservoir heterogeneity. As an example, history matching or other feedback may be utilized to revise a model, for example, consider revising a reservoir model to account for heterogeneities, whether pre-existing, due to injection of gas, liberation of gas, etc. As explained, an operational process can alter a reservoir in a heterogeneous manner, for example, due to hydrate saturation that may impact permeability, which, in turn, can impact how fluid (e.g., gas and/or liquid) moves in the reservoir.

As an example, a framework can account for wellbore conditions and, for example, control of one or more wellbore conditions. As an example, one or more wellbore conditions may be effectively controlled for efficient production of hydrates. As to some examples of control of wellbore conditions, consider solids control, temperature control, pressure control, and wellbore fluid levels control. As an example, operations may aim to reduce occurrence of shut-in events, for example, due to well pressure rises and hydrates formed within a well. Such events may be precipitated by solids production, noting that effective application of downhole heating and water level control may help to mitigate such events.

As an example, a reservoir simulator can provide for modeling a formation and one or more conduits such as one or more wellbore conduits. In such an example, simulation results may provide for indications of how injection can be controlled in the field to reduce risk of undesirable events. For example, solid phase modeling capabilities of a reservoir simulator that is operatively coupled to a ML model for hydrate information can provide for indications of solid phase issues, whether in a formation or a conduit (e.g., injection conduit and/or production conduit).

As an example, a framework can include accessing experimental data (e.g., laboratory data, field data, etc.) pertaining to kinetics of hydrate formation where the data can provide for building a ML model with optimized hyperparameters where the built ML model can provide for robust and precise predictions suitable for use by a reservoir simulator. For example, consider a reservoir simulator that can include such a built ML model or that can be operatively coupled to such a built ML model. As an example, a built ML model may be referred to as a trained ML model where, for example, a trained ML model may be a tree type of model that has been subject to hyperparameter optimization for purposes of robust performance for output of precise values that can be utilized by a simulator where the simulator operates reliably such that convergence can be achieved for a simulation problem to generate meaningful simulation results.

As to efficient use of experimental data, a random forest ML model may be trained in a data-efficient manner. As explained, a random forest can be generated using out-of-bag (oob) error, which may be viewed as a type of validation. As such, in random forests, a separate test set to validate is not required. As explained, validation can be estimated internally during a run, as follows: the forest is built on training data, where each tree is tested on a fraction of the samples (approximately one-third, etc.) not used in building that tree, which provides the out of bag error estimate (e.g., an internal error estimate of a random forest as it is being constructed).

As explained, a simulator can include one or more of the features of the INTERSECT simulator. For example, a simulator can include solid phase capabilities. As explained, hydrates can host various types of constituents, which may be referred to as a hydrate guest. For example, consider methane as a hydrate guest that may be displaced by carbon dioxide as a hydrate guest. In such an example, the solid phase (e.g., hydrates or hydrate phase) can interact with constituents of one or more other phases. The interactions and consequences thereof can be profound given that, in various examples, 1 cubic meter of hydrates can host 600 cubic meters of gas. As an example, a simulation may be performed to estimate a volume of gas that can be hosted by hydrates in a subsurface geologic environment.

As an example, a ML model can be utilized in a manner to bypass a flash package. As an example, a ML model can be utilized in a manner that is coupled to a flash package, which may be, for example, an oil flash package for gas and liquid phases, where the ML model provides information for a solid phase. An oil flash package may provide output as to which component belongs to a particular phase where such phases can include a gas phase and a liquid phase (e.g., phase leveling). In an example of flue gas injection simulation, consider forming a solid phase where the flue gas is hosted in a hydrate. As such phenomena is not handled by an oil flash package for gas and liquid phases, a ML model can be called to provide for predictions as to hydrate dynamics and hence solid phase dynamics (e.g., assuming hydrates are the predominant solids of the solid phase).

As an example, a reservoir simulator can implement a ML model for purposes of computations for solid phase phenomena. For example, a ML model can output values for given inputs where the output values can indicate, for various cells of a model, where hydrate is forming and/or where hydrate is dissolving (e.g., dissipating). In such an example, as each of the cells has a corresponding volume, the hydrate dynamics can determine how much of the volume is occupied by hydrate as a solid phase. Thus, a ML model for hydrate dynamics can inherently provide for solid phase information for a cell or cells of a model. Where hydrates are of interest, the solid phase may be inherently determined through use of a ML model trained to generate, for example, hydrate equilibrium pressure. As explained, hydrates are formed from water; thus, some amount of water must be present for purposes of hydrate formation.

As an example, a ML model can provide for computation of an amount of hydrate formed and/or dissolved for conditions in space (e.g., physical conditions) at a given time. For example, in the model of FIG. 15, a simulator can provide for results for each cell, optionally with respect to time. In such an example, a strategy may be developed that aims to control permeability with respect to time. For example, consider a strategy that provides for transport of flue gas a distance from a perforated conduit such that hydrates do not form rapidly adjacent to the perforated conduit in a manner that reduces permeability such that regions a further distance beyond the perforated conduit are restricted from receiving flue gas injected via the perforated conduit.

As an example, an operational strategy can aim to promote hydrate build-up a sufficient distance into a formation as measured from a wellbore. As explained, hydrate build-up can be associated with exchange-driven methane enrichment of a gas phase at a displacement front, where free water is available to form additional hydrate. With continued injection, a high hydrate saturation front can progressively move outward from a wellbore. As an example, a reservoir simulation may aim to assess a maximum hydrate saturation, which may account for permeability and utilization of reservoir volume. As explained, nitrogen may be utilized as part of an operational strategy. For example, consider injecting a mixture of carbon dioxide and nitrogen with mole percentages of approximately 2 parts to approximately 4 parts of nitrogen per part of carbon dioxide (e.g., 25 mole percent CO₂ and 75 mole percent N₂).

As an example, a method can include generating a Hall plot, which may be utilized to indicate changes in injectivity. A Hall plot can show cumulative pressure-days versus cumulative volume injected, which can provide an indication as to whether formation permeability is increasing, decreasing or remaining constant over an injection period.

As explained, a reservoir simulator such as the INTERSECT simulator can be operatively coupled to a ML model for purposes of handling hydrate dynamics. In such an example, the ML model can provide for solid phase computations, where the solid phase includes one or more types of hydrates. As explained, a reservoir simulator may provide for simulation of various scenarios such as, for example, one or more of methane production, sequestration of carbon dioxide or flue gas, etc. As an example, a reservoir simulator may be suitable for handling hydrogen as a hydrate guest. For example, consider displacement of hydrogen from hydrates for production of hydrogen from a subsurface geologic environment.

As explained, for various reasons such as offshore reservoirs being developed in ever deeper and colder waters, gas hydrates are of increasing interest, particularly as to flow disruptions, equipment, and safety hazards arising from the hydrate plug formation. In addressing plug formation, low-dosage hydrate inhibitors such as kinetic inhibitors can compete with thermodynamic inhibitors such as methanol, which makes accurate information regarding the hydrate equilibrium conditions quite helpful in determining an optimal hydrate control strategy.

As an example, one or more modeling approaches for plug formation may be utilized for modeling sequestration or other trapping of molecules. As an example, a method can include utilizing one or more machine learning (ML) models, for example, to identify regions of interest, to model hydrates (e.g., formation, dissipation, etc.), to model larger scale operations (e.g., to utilize hydrates, form hydrates, dissipate hydrates, etc.), etc. An article by Landgrebe and Nkazi, “Toward a Robust, Universal Predictor of Gas Hydrate Equilibria by Means of a Deep Learning Regression,” ACS omega 4.27 (2019): 22399-22417 is incorporated by reference herein in its entirety.

As an example, a ML model may be or include a multivariate regression model that may be utilized for generalizing hydrate equilibria over a wide range of conditions, with results competing with thermodynamic models. As an example, a ML model may be or include a multilayer perceptron neural network of multiple hidden layers that can be trained via supervised learning, for example, via backpropagation. In such an example, the trained ML model may be implemented to predict uninhibited hydrate equilibrium pressure for a range of gas mixtures with various input features. For example, consider training from a dataset of more than one thousand equilibrium points, where about two-thirds are for multicomponent gases. As an example, a method may aim to perform hyperparameter optimization without overfitting, optionally with stratified holdout to help ensure testing a wide range of conditions.

As an example, a ML model may be capable of outperforming one or more types of thermodynamic models. As an example, one or more auxiliary models may be utilized to determine multicomponent prediction capability and dependency on individual data sources. A trained model may provide for multicomponent data prediction with results that adequately generalize hydrate equilibria. Such a model can be suited to predicting unseen data in a robust manner.

As an example, a ML model can provide for one or more of physical, chemical, electrical, magnetic model integration. As explained, hydrates have been studied in the oil and gas industry generally as a flow assurance challenge. Experimental data are available that can be utilized for generating predictive models that can, for example, output predictions as to hydrate formation conditions. As an example, a ML model may be trained to predict and/or identify conditions and/or regions that may be suitable for one or more purposes such as, for example, sequestration, etc.

As explained, a hydrate reservoir may provide potential for carbon management, for example, consider one or more of production of natural gases, carbon capture and storage. Subsurface modelling of hydrate formation may be performed with one or more simple hydrate stability models and/or may be performed using one or more ML models.

As an example, one or more ML models can be generated that account for multiple hydrocarbon components and associated gases (e.g., C1-C4, CO₂, N₂ and H₂S). As an example, a model may also provide for phase combinations for hydrate equilibrium. As an example, a trained ML model may be utilized in one or more reservoir simulation models to predict hydrate equilibrium pressure, and therefore hydrate formation and dissociation kinetics.

A ML model can be constructed to predict hydrate formation to investigate how methane can be replaced by CO₂. Together with a reservoir simulator (e.g., INTERSECT, etc.), for a given formation, such an approach can provide a way to determine how much CO₂ can be trapped in the hydrates phase while producing CH₄. As an example, a method can provide for identification of opportunities, planning of operations, execution of operations, etc., for storage of CO₂ in one or more hydrates phases, for example, offering a safe trapping mechanism for carbon sequestration purposes.

As an example, a ML model may be trained to predict phase labelling to help in understanding of thermodynamics as to composition in a phase with reduced computing. Various existing Equations of State (EOS) techniques are not capable of making such predictions. A ML model based approach can help to reduce study time while screening one or more subsurface formations as to ability to hold a desired amount of CO₂, for example, by displacing methane, which may be produced for one or more purposes. Storing CO₂ in hydrates phases can provide a cost-effective solution as it tends to demand lesser monitoring and tends to be safer than other CO₂ sequestration approaches (e.g., in supercritical state, etc.).

As an example, a model, a method, a system, etc., may account for the fact that various hydrates can be dissociated using a magnetic field as may be properly adjusted. As an example, a magnetic field may be utilized to interfere with the inner vibration of the molecules and destabilize water formed lattices that would liberate CO₂ and/or methane.

As an example, a method can include pre-processing and/or tailoring CO₂ for enhanced and/or improved chemistry. For example, CO₂ within a flue gas can be stored while displacing methane trapped in hydrate phase. This natural mechanism may occur at certain range of pressure and temperature as well flue gas composition.

As mentioned, a method may include integration with a reservoir simulator (e.g., INTERSECT, etc.) and/or one or more other types of simulator. As an example, the INTERSECT simulator may provide output relevant to CO₂/CH₄ clathrates. As an example, one or more ML models can predict hydrate equilibrium for given input(s) where such one or more ML models may be trained using available data (e.g., private, public, etc.). In such an example, a ML model can takes as in input a detailed composition of hydrate formers (C1, C2, C3, i-C4, n-C4, N₂, CO₂, H₂S). In such an example, phase labels can also be included in the features for the ML model. As an example, a model can be trained using more than 1000 data points and updated as additional data are collected.

As an example, a ML model can be used to predict hydrate stability. In such an example, when combined with one or more reservoir simulation models, a workflow can enable more accurate prediction of hydrate formation/dissociation in one or more subsurface reservoirs. As an example, a ML model may be embedded within a simulator (e.g., a reservoir simulator, etc.) to permit a rapid investigation of how much CO₂ can be stored, for example, while displacing methane subject to the relevant subsurface conditions.

As mentioned, a method can include identification of one or more regions for storage of CO₂, optionally with or without methane displacement and/or production. As an example, a system can provide an efficient way to investigate, rapidly, whether a given formation would be suitable to store CO₂ while displacing the CH₄ in hydrate phase. Such a system can provide for simulation of the swapping between CO₂ and methane in hydrates.

As an example, hydrates phase labelling using a machine learning technique rather than using EOS can be computational effective and cost effective. As an example, a method can include implementation of one or more geomechanical models and/or geomechanical simulators, for example, to evaluate stress-strain that may be induced while storing CO₂ in hydrate format and/or displacing methane.

As an example, kinetics can pace or otherwise limit an operation or operations. As an example, a system may provide for modeling kinetics and/or tailoring kinetics to make an operation or operations more efficient (e.g., to optimize one or more operations). For example, consider a combined simulator and ML model based approach where special variability with respect to local properties can provide for mapping zones of interest where CO₂/CH₄ swapping may occur and how much volumes can be stored. In such an example, a system may provide for an order of operations, which may be a region by region order that can optimize operations (e.g., maximize effectiveness of each region, etc.).

As an example, a system can provide for planning and/or replanning. For example, consider planning as to a facility or facilities that can produce carbon dioxide and that can consume methane. In such an example, replanning may occur responsive to one or more changes in a facility or facilities.

As an example, a system can provide for execution of one or more processes that include or are related to carbon dioxide sequestration. For example, consider drilling of a new well or in an existing well, preprocessing CO₂ or a waste stream that includes CO₂, utilization of one or more magnetic field enhancements/techniques, collection of CH₄, execution related to kinetics, etc.

As an example, a system can provide for operations that can store CO₂ clathrate (e.g., CO₂ ice) (e.g., as a slurry, etc.). Such a system may include performing operations on an existing well to a region/reservoir with suitable conditions for carbon dioxide sequestration. As an example, operations can include injecting/pumping CO₂ ice to reservoir.

As an example, a system can provide for monitoring or assessment operations such as, for example, imaging operations. For example, consider seismic imaging of a region as part of monitoring (e.g., as to stress, strain, etc.) and/or as part of assessing (e.g., as to formation structure, fluid content, etc.).

As explained, a system can provide for magnetic field considerations and/or modeling. For example, clathrates may form, behave, etc., in a manner that depends on a magnetic field (e.g., static, dynamic, tool induced, etc.). As an example, an electromagnetic simulator may be implemented that accounts for natural and/or artificial fields (e.g., magnetic and/or EM fields) that may interact with one or more processes regarding hydrates, etc. As an example, a Maxwell equations solver may be implemented within a simulator to understand how magnetic field(s) may be utilized in one or more processes (e.g., for sequestration of carbon as CO₂, for liberation of methane, etc.).

As an example, a system can include a stress-strain simulator where, for example, a risk of settling, expanding, cracking, etc., may occur. As explained, volume phenomena may arise such as changes in porosity, permeability, etc. Such an approach may help in determining stability of a field. As an example, a simulation may account for changes in reservoir conditions with respect to an injection process. For example, as porosity changes due to hydrate changes, an ability to inject CO₂ may change. For example, an injection pressure may be increased to effectively drive the CO₂ into the reservoir.

As an example, a system can include a surface network simulator (e.g., for injection of CO₂ and production of CH₄, etc.). As an example, a system can provide for simulating operations for a field. For example, consider determining a number of wells for injection and/or production. Such an approach may include determining well trajectories, well perforations, etc. As an example, an overall field strategy may be determined that can account for changes to a formation in a carbon dioxide storage operation such that a number of wells are planned for use in a particular manner to effectively optimize the capacity of the formation.

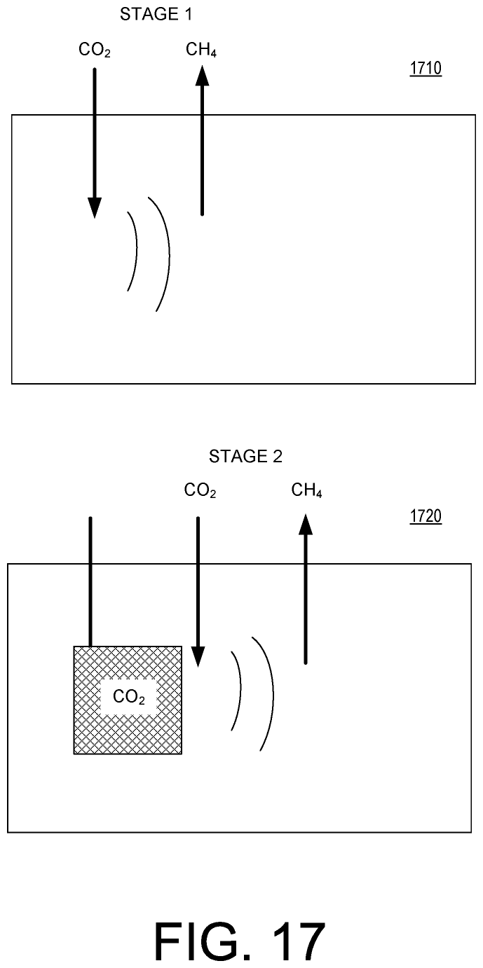

FIG. 17 shows an example of staged operations 1710 and 1720. As shown, the first stage 1710 (Stage 1) may utilize an injection well and a production well while the second stage may utilize the production well now as an injection well and use a third well as a production well. As shown, the stages may be planned or otherwise controlled based on one or more conditions such as amount of carbon dioxide injected, breakthrough of carbon dioxide, etc. As indicated in the second stage 1720 (Stage 2), a carbon dioxide “filled” region may act as a barrier such that injected carbon dioxide flows in a particular direction (e.g., to a region that can accommodate the carbon dioxide via sequestration, etc.). As explained, field operations may be staged where, for example, injection wells and/or production wells may be changed as to function from stage to stage.

As an example, a system may be utilized for execution of one or more field operations such as, for example, drilling wells, preprocessing CO₂, use of magnetic field enhancements/techniques, collection of CH₄, kinetics, timings, etc. As an example, a system may account for detrimental hydrate formation, as may be associated with plugging, etc. For example, a process may be performed in a manner that aims to minimize plugging risks. In such an example, one or more ML models may be utilized to determine one or more aspects of phenomena that may give rise to a plugging risk. For example, a ML model for carbon dioxide sequestration may provide output that is germane to plugging risk.

As an example, a system can provide for simulations as to storing CO₂ clathrate as an ice, a slurry, etc. As an example, a system may provide for analysis of an existing well to region/reservoir with suitable conditions and/or for injecting/pumping CO₂ ice into reservoir.

As explained, a ML model-based approach can provide for output of information germane to swapping between CO₂ and CH₄ in hydrates. Such an approach can provide for evaluation of amount of CO₂ stored in a hydrates phase for a range of pressures and temperatures. Such an approach may or may not be supplemented with one or more equations of state (EOS), which tend to be computationally expensive (e.g., flash, etc.). As an example, a system may provide for simulation of CO₂ injection in one or more manners (e.g., sub-critical, critical, super-critical, etc.).

As an example, a system can provide for risk analysis, stability analysis, contingency analysis, etc. As an example, a system may provide for well bore stability and injection sustainability analysis, for example, to calibrate and ensure CO₂ injection continuity for a multiyear disposal.

As an example, a system can provide for simulation of storing CO₂ in hydrates while swapping with CH₄. In such an example, CO₂ storage in hydrate state can be simulated to understand how to best utilize capacity, noting that it may hold, for example, 600 times the volume in standard conditions.

One or more ML technique combined with reservoir simulation can provide for study subsurface formations with respect to suitability to store CO₂ or CO₂ flue gas in hydrates formation and determine the optimal operating conditions.

As to geomechanics, one or more simulators can provide for analysis of possible fracturing. For example, consider utilizing a hydraulic fracturing simulator that can be adapted to injection of carbon dioxide where one or more ML models may be utilized for dynamics as to porosity, permeability, pressures, temperatures, etc. In such an example, geomechanics information can be generated and compared to stresses that may exist in a field to assess risk of fracturing, etc., which may impact an environment, a process, stability, etc. As an example, a system can provide for utilization of a hydrate reservoir in optimal way by replacing CH₄ by CO₂ in hydrates phases while keeping reservoir formation stability from a rock mechanics point of view.

As explained, a system can include one or more data-driven models (e.g., trained ML models, etc.) and one or more physics-based simulation models. In such an example, a simulator may operate by iteratively accessing one or more ML models as to appropriate phenomena associated with hydrate reservoir utilization.

As an example, a system can provide for determining suitability of a given reservoir for storing CO₂ or CO₂ flue gas in hydrate state. Such a system can provide for, in a timely manner, rapid screening to investigate an optimal choice of reservoir characteristics and how much CO₂ may be stored, for example, while keeping pace of methane production.

As an example, a system can effectively embed hydrate experimental data via implementing ML learning features within reservoir dynamic behavior modelling for storing CO₂ while producing CH₄. As explained, one or more ML models may be embedded within a system that can integrate the one or more ML models with one or more simulators (e.g., reservoir, geomechanics, etc.).

As an example, a method can include pore to process simulation of CO₂ storage in hydrate states, optionally while producing CH₄. As explained, hydrates have been, in the oil and gas industry, generally presented as a flow assurance challenge. Experimental data and reservoir data are available that can be utilized in machine learning for prediction of hydrate formation conditions and/or other kinetics, which may consider changes in shape, size, liberation conditions, stabilization conditions, etc. Hydrate reservoirs present potential solutions related to carbon management, including production of natural gases, carbon capture and storage. Subsurface modelling of hydrate formation can include building a machine learning (ML) model to account for multiple hydrocarbon components and associated gases (e.g., C1-C4, CO₂, N₂, H₂S, etc.). A model may also account for phase combinations for hydrate equilibrium. As explained, such a model can be operatively coupled to one or more simulators. For example, when a trained ML model (or ML models) is tied to a reservoir simulator, a method can provide for prediction of hydrate equilibrium pressure, and therefore hydrate formation and dissociation kinetics, which may be utilized in simulation of reservoir dynamics, etc. (e.g., for production of methane, storage of CO₂, etc.).

As an example, a ML model and reservoir simulator based approach, for a given formation, can determine how much CO₂ can be trapped in hydrates while producing CH₄. Such an approach can help facilitate a way to store CO₂ in hydrate as a trapping mechanism for carbon sequestration.

As an example, a ML model can provide for phase labeling to help with a thermodynamic understanding as to composition. Such an approach can be robust and efficient, for example, able to march incrementally with a reservoir and/or other simulator. Storing CO₂ in hydrates (e.g., hydrate phases, etc.) can be a cost-effective solution as it can demand less monitoring and be safer than CO₂ sequestration in a supercritical state.

An article by Uddin et al. “Numerical studies of gas hydrate formation and decomposition in a geological reservoir.” Journal of Energy Resources Technology 130.3 (2008), is incorporated by reference herein in its entirety.

In the Uddin article, numerical modeling of gas hydrates is utilized to provide an integrated understanding of various process mechanisms controlling methane (CH₄) production from hydrates and carbon dioxide (CO₂) sequestration as a gas hydrate in geologic reservoirs. In particular, a numerical unified kinetic model (e.g., a physics based model) is implemented that is coupled with a compositional thermal reservoir simulator to simulate the dynamics of CH₄ and CO₂ hydrate formation and decomposition in a geological formation. In the Uddin article, the kinetic model contains two mass transfer equations: one equation converts gas and water into hydrate and the other equation decomposes hydrate into gas and water. As explained, a physics based model can be impractical for use with a reservoir simulator.

As article by Hong and Pooladi-Darvish (2003), “A Numerical Study on Gas Production From Formations Containing Gas Hydrates,” Petroleum Society's Canadian International Petroleum Conference, Calgary, AB, June 10-12, Paper No. 2003-060, is incorporated by reference herein in its entirety, which utilizes a numerical model (e.g., physics based model). As explained, a physics based model can be impractical for use with a reservoir simulator.

A National Energy Technology Laboratory, Final Technical Report, by Schoderbek et al., entitled “ConocoPhillips gas hydrate production test”, submitted on 20 Jul. 2013 (DOE Award No.: DE-NT0006553) is incorporated by reference herein in its entirety, which includes field test data analyzed by a rudimentary tank based model that demonstrated an inability to match most aspects of the field test data.

As explained, a method can utilize a model that is not physics based or that may be in part physics based. As an example, a trained machine learning model (ML model) can include an artificial neural network model for prediction of hydrate equilibrium based data. For example, such a ML model can take as input a detailed composition of hydrate formers (e.g., C1, C2, C3, i-C4, n-C4, N₂, CO₂, H₂S) and phase labels can also be included in features of the ML model. In such an example, the ML model can be trained with thousands of data points and can be updated with additional data.

As an example, a trained ML model can be used to predict hydrate stability. When combined with reservoir simulation models, such an approach can enable more accurate prediction of hydrate formation/dissociation in subsurface reservoirs. Such an approach can be used in CO₂ sequestration simulation, for example, to understand possible hydrate petrophysical impacts such as temperature effects, permeability reduction, stress, strain, etc.

As an example, a method can include evaluating the amount of CO₂ storable in hydrates for wide range of pressures and temperatures. As explained, a hydrates phase labeling using machine learning (e.g., rather than using EOS) can be more efficient and allow for simulator coupling. Such an approach can allow for study a subsurface formation with respect to suitability to store CO₂ or CO₂ flue gas in hydrates formation and, for example, determine the optimal operating conditions. Such an approach can provide for simulation of replacing CH₄ by CO₂ in hydrates phases while keeping reservoir formation stability from a rock mechanics point of view. Rock mechanics has proven to be a relevant concern in carbon sequestration and even led to consequences for local residents, buildings, etc. A combined approach that utilizes one or more ML models and one or more simulators can provide for assurances, optimal operational conditions, etc., which may aim to reduce risk of detrimental rock mechanics. Reservoir operational efficiencies, ability to store CO₂, ability to produce CH₄, etc., may be outputs of a method. In instances where operations are coupled to CO₂ production and/or CH₄ consumption, one or more loops may be established, which can call for sizing, controlling, etc., such production and consumption operations (e.g., of a surface facility or facilities, etc.). For example, a system may provide for rapid screening to investigate an optimal choice of reservoir characteristics and how much CO₂ can be stored while keeping the pace of CH₄ production, which may be consumed to produce more CO₂.

As an example, one or more simulators can be physics based and utilize one or more numerical techniques, which may march forward in time or otherwise operate incrementally (e.g., Newton's method, etc.). In such an example, one or more trained ML models can be operatively coupled and/or embedded within a simulator (e.g., a simulation framework, etc.) to provide output based at least in part on simulated conditions.

As to types of machine learning models, consider one or more examples such as a support vector machine (SVM) model, a k-nearest neighbors (KNN) model, an ensemble classifier model, a neural network (NN) model, etc. As an example, a machine learning model can be a deep learning model (e.g., deep Boltzmann machine, deep belief network, convolutional neural network (CNN), stacked auto-encoder, etc.), an ensemble model (e.g., random forest, gradient boosting machine, bootstrapped aggregation, AdaBoost, stacked generalization, gradient boosted regression tree, etc.), a neural network model (e.g., radial basis function network, perceptron, back-propagation, Hopfield network, etc.), a regularization model (e.g., ridge regression, least absolute shrinkage and selection operator, elastic net, least angle regression), a rule system model (e.g., cubist, one rule, zero rule, repeated incremental pruning to produce error reduction), a regression model (e.g., linear regression, ordinary least squares regression, stepwise regression, multivariate adaptive regression splines, locally estimated scatterplot smoothing, logistic regression, etc.), a Bayesian model (e.g., naïve Bayes, average on-dependence estimators, Bayesian belief network, Gaussian naïve Bayes, multinomial naïve Bayes, Bayesian network), a decision tree model (e.g., classification and regression tree, iterative dichotomiser 3, C4.5, C5.0, chi-squared automatic interaction detection, decision stump, conditional decision tree, M5), a dimensionality reduction model (e.g., principal component analysis, partial least squares regression, Sammon mapping, multidimensional scaling, projection pursuit, principal component regression, partial least squares discriminant analysis, mixture discriminant analysis, quadratic discriminant analysis, regularized discriminant analysis, flexible discriminant analysis, linear discriminant analysis, etc.), an instance model (e.g., k-nearest neighbor, learning vector quantization, self-organizing map, locally weighted learning, etc.), a clustering model (e.g., k-means, k-medians, expectation maximization, hierarchical clustering, etc.), etc.

As an example, a machine model, which may be a machine learning model, may be built using a computational framework with a library, a toolbox, etc., such as, for example, those of the MATLAB framework (MathWorks, Inc., Natick, Massachusetts). The MATLAB framework includes a toolbox that provides supervised and unsupervised machine learning algorithms, including support vector machines (SVMs), boosted and bagged decision trees, k-nearest neighbor (KNN), k-means, k-medoids, hierarchical clustering, Gaussian mixture models, and hidden Markov models. Another MATLAB framework toolbox is the Deep Learning Toolbox (DLT), which provides a framework for designing and implementing deep neural networks with algorithms, pretrained models, and apps. The DLT provides convolutional neural networks (ConvNets, CNNs) and long short-term memory (LSTM) networks to perform classification and regression on image, time-series, and text data. The DLT includes features to build network architectures such as generative adversarial networks (GANs) and Siamese networks using custom training loops, shared weights, and automatic differentiation. The DLT provides for model exchange various other frameworks.

As an example, the TENSORFLOW framework (Google LLC, Mountain View, CA) may be implemented, which is an open source software library for dataflow programming that includes a symbolic math library, which can be implemented for machine learning applications that can include neural networks. As an example, the CAFFE framework may be implemented, which is a DL framework developed by Berkeley AI Research (BAIR) (University of California, Berkeley, California). As another example, consider the SCIKIT platform (e.g., scikit-learn), which utilizes the PYTHON programming language. As an example, a framework such as the APOLLO AI framework may be utilized (APOLLO.AI GmbH, Germany). As an example, a framework such as the PYTORCH framework may be utilized (Facebook AI Research Lab (FAIR), Facebook, Inc., Menlo Park, California). As an example, a DATAIKU framework may be utilized (Dataiku, New York, New York).

As an example, a training method can include various actions that can operate on a dataset to train a ML model. As an example, a dataset can be split into training data and test data where test data can provide for evaluation. A method can include cross-validation of parameters and best parameters, which can be provided for model training.

The TENSORFLOW framework can run on multiple CPUs and GPUs (with optional CUDA (NVIDIA Corp., Santa Clara, California) and SYCL (The Khronos Group Inc., Beaverton, Oregon) extensions for general-purpose computing on graphics processing units (GPUs)). TENSORFLOW is available on 64-bit LINUX, MACOS (Apple Inc., Cupertino, California), WINDOWS (Microsoft Corp., Redmond, Washington), and mobile computing platforms including ANDROID (Google LLC, Mountain View, California) and IOS (Apple Inc.) operating system based platforms.

TENSORFLOW computations can be expressed as stateful dataflow graphs; noting that the name TENSORFLOW derives from the operations that such neural networks perform on multidimensional data arrays. Such arrays can be referred to as “tensors”.

As an example, a device and/or distributed devices may utilize TENSORFLOW LITE (TFL) or another type of lightweight framework. For example, one or more pieces of equipment at a wellsite may include and/or utilize a lightweight framework suitable for execution of a machine learning model (e.g., a trained ML model, etc.). TFL is a set of tools that enables on-device machine learning where models may run on mobile, embedded, and loT devices. TFL is optimized for on-device machine learning, by addressing latency (no round-trip to a server), privacy (no personal data leaves the device), connectivity (Internet connectivity is demanded), size (reduced model and binary size) and power consumption (e.g., efficient inference and a lack of network connections). Multiple platform support, covering ANDROID and iOS devices, embedded LINUX, and microcontrollers. Diverse language support, which includes JAVA, SWIFT, Objective-C, C++, and PYTHON. High performance, with hardware acceleration and model optimization. Machine learning tasks may include, for example, data processing, image classification, object detection, pose estimation, question answering, text classification, etc., on multiple platforms.

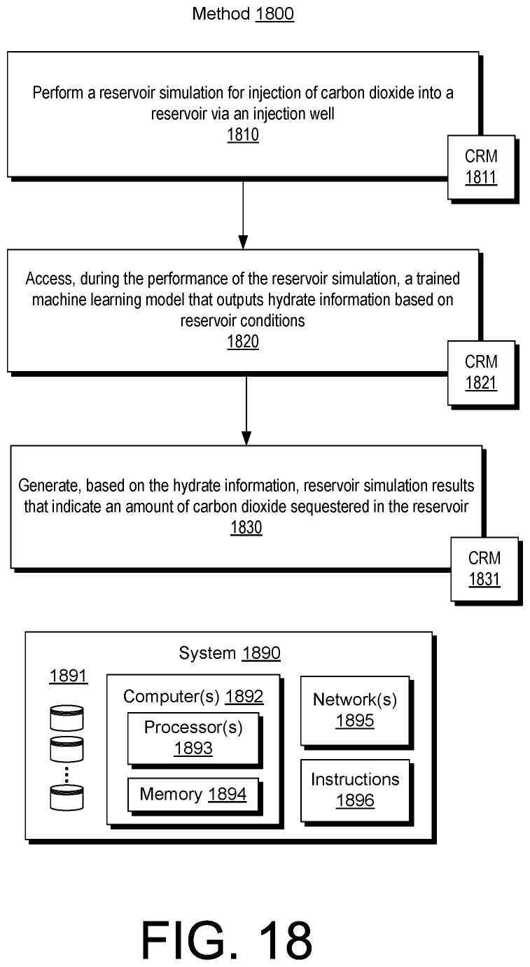

FIG. 18 shows an example of a method 1800 that includes a performance block 1810 for performing a reservoir simulation for injection of carbon dioxide into a reservoir via an injection well; an access block 1820 for, during the performing, accessing a trained machine learning model that outputs hydrate information based on reservoir conditions; and a generation block 1830 for, based on the hydrate information, generating reservoir simulation results that indicate an amount of the carbon dioxide sequestered in the reservoir.

As explained with respect to the GUI 900 of FIG. 9, various regions can include reservoirs that can be assessed for one or more purposes, which may include carbon dioxide sequestration. In such an example, carbon dioxide may be a component of flue gas. For example, consider a plant that combusts a hydrocarbon energy source in a process that generates flue gas. In such an example, the flue gas may be injected into a reservoir that has at least hydrate-based carbon dioxide sequestration capabilities. As explained, such a reservoir may also include methane, which may be liberated responsive to flue gas injection into the reservoir. In such an example, liberated methane (e.g., displaced from hydrates by carbon dioxide) may be directed to a plant or plants as a hydrocarbon energy source. As explained, a plant and a reservoir may be coupled in a closed cycle process with respect to carbon. For example, methane produced by the reservoir may be combusted by the plant to form carbon containing flue gas that can be directed back into the reservoir. Such a closed cycle process may continue until the methane is depleted or no longer producible from the reservoir (e.g., due to exhaustion, permeability changes, etc.).

The method 1800 is shown in FIG. 18 in association with various computer-readable media (CRM) blocks 1811, 1821, and 1831. Such blocks generally include instructions suitable for execution by one or more processors (or processor cores) to instruct a computing device or system to perform one or more actions. While various blocks are shown, a single medium may be configured with instructions to allow for, at least in part, performance of various actions of the method 1800. As an example, a computer-readable medium (CRM) may be a computer-readable storage medium that is non-transitory and that is not a carrier wave. As an example, one or more of the blocks 1811, 1821, and 1831 may be in the form processor-executable instructions.

In the example of FIG. 18, a system 1890 includes one or more information storage devices 1891, one or more computers 1892, one or more networks 1895, and instructions 1896. As to the one or more computers 1892, each computer may include one or more processors (e.g., or processing cores) 1893 and memory 1894 for storing the instructions 1896, for example, executable by at least one of the one or more processors 1893 (see, e.g., the blocks 1811, 1821, and 1831). As an example, a computer may include one or more network interfaces (e.g., wired or wireless), one or more graphics cards, a display interface (e.g., wired or wireless), etc.

As an example, a method can include performing a reservoir simulation for injection of carbon dioxide into a reservoir via an injection well; and, during the performing, accessing a trained machine learning model that outputs hydrate information based on reservoir conditions. In such an example, performing the reservoir simulation can simulate production of methane from a production well responsive to the injection of carbon dioxide. For example, consider injection of carbon dioxide that displaces methane from the reservoir where the carbon dioxide may displace methane from hydrates.

As an example, a trained machine learning model can output hydrate equilibrium information. For example, consider hydrate equilibrium information that pertains to carbon dioxide hydrates, methane hydrates or carbon dioxide hydrates and methane hydrates.

As an example, a method can include accounting for changes in permeability of a reservoir based at least in part on hydrate information. As an example, a method can include performing reservoir simulation that simulates geomechanics.

As an example, injection of carbon dioxide in a process may depend on a combustion process at a surface facility. For example, consider a surface facility that combusts methane in the presence of oxygen to produce the carbon dioxide.

As an example, a method can include characterizing one or more reservoirs as to ability to suitable store carbon. In such an example, a method may include identifying one or more reservoirs from a group of reservoirs. For example, consider identifying that includes accessing a trained machine learning model to determine an ability of a reservoir to sequester carbon dioxide.

As an example, a method can include generating a trained machine learning model. For example, consider generating via accessing field data and laboratory data. In such an example, generating can include accessing pressure and temperature data for a plurality of hydrate compositions. For example, consider hydrate compositions that include carbon dioxide hydrate compositions and methane hydrate compositions. As explained, a machine learning model can be a tree type of model that includes tree structures where such tree structures can be utilized to make decisions based on inputs where output of a tree structure can be a value such as, for example, a value for hydrate behavior, conditions, etc. (e.g., hydrate information). In various examples, a value can be a hydrate equilibrium value such as a hydrate equilibrium pressure. As explained, an ensemble of trees may be utilized for purposes of classification and/or regression. As to classification, each tree may output a vote for a class, which may represent a hydrate information class (e.g., a value or a range of values). As to regression, each tree may output a value where values from a number of trees may be combined, for example, via averaging, to arrive at an ultimate value from the number of trees. In such an example, the ultimate value may represent hydrate information such as, for example, a hydrate pressure equilibrium value.

As an example, a system can include one or more processors; a memory accessible to at least one of the one or more processors; processor-executable instructions stored in the memory and executable to instruct the system to: perform a reservoir simulation for injection of carbon dioxide into a reservoir via an injection well; during the reservoir simulation, access a trained machine learning model that outputs hydrate information based on reservoir conditions; and, based on the hydrate information, generate reservoir simulation results that indicate an amount of the carbon dioxide sequestered in the reservoir. In such an example, processor-executable instructions stored in the memory and executable to instruct the system may generate the trained machine learning model. As an example, processor-executable instructions stored in the memory and executable to instruct the system may perform a geomechanics simulation.

As an example, one or more computer-readable storage media can include processor-executable instructions to instruct a computing system to: perform a reservoir simulation for injection of carbon dioxide into a reservoir via an injection well; during the simulation, access a trained machine learning model that outputs hydrate information based on reservoir conditions; and, based on the hydrate information, generate reservoir simulation results that indicate an amount of the carbon dioxide sequestered in the reservoir.

As an example, a computer program product can include one or more computer-readable storage media that can include processor-executable instructions to instruct a computing system to perform one or more methods and/or one or more portions of a method.

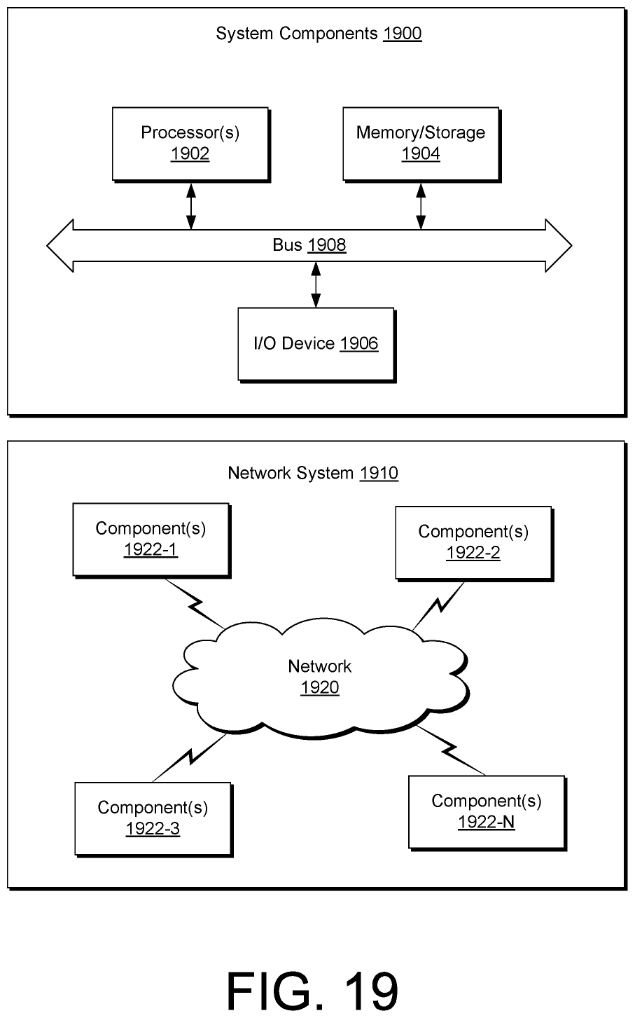

FIG. 19 shows components of an example of a computing system 1900 and an example of a networked system 1910 with a network 1920. The system 1900 includes one or more processors 1902, memory and/or storage components 1904, one or more input and/or output devices 1906 and a bus 1908. In an example embodiment, instructions may be stored in one or more computer-readable media (e.g., memory/storage components 1904). Such instructions may be read by one or more processors (e.g., the processor(s) 1902) via a communication bus (e.g., the bus 1908), which may be wired or wireless. The one or more processors may execute such instructions to implement (wholly or in part) one or more attributes (e.g., as part of a method). A user may view output from and interact with a process via an I/O device (e.g., the device 1906). In an example embodiment, a computer-readable medium may be a storage component such as a physical memory storage device, for example, a chip, a chip on a package, a memory card, etc. (e.g., a computer-readable storage medium).

In an example embodiment, components may be distributed, such as in the network system 1910. The network system 1910 includes components 1922-1, 1922-2, 1922-3, . . . 1922-N. For example, the components 1922-1 may include the processor(s) 1902 while the component(s) 1922-3 may include memory accessible by the processor(s) 1902. Further, the component(s) 1922-2 may include an I/O device for display and optionally interaction with a method. A network 1920 may be or include the Internet, an intranet, a cellular network, a satellite network, etc.

As an example, a device may be a mobile device that includes one or more network interfaces for communication of information. For example, a mobile device may include a wireless network interface (e.g., operable via IEEE 802.11, ETSI GSM, BLUETOOTH, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that can be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A method comprising:
performing a reservoir simulation for injection of carbon dioxide into a reservoir via an injection well;
during the performing, accessing a trained machine learning model that outputs hydrate information based on reservoir conditions; and
based on the hydrate information, generating reservoir simulation results that indicate an amount of the carbon dioxide sequestered in the reservoir.

2. The method of claim 1, wherein the performing the reservoir simulation comprises simulating production of methane from a production well responsive to the injection of carbon dioxide.

3. The method of claim 2, wherein the injection of carbon dioxide displaces methane from the reservoir.

4. The method of claim 3, wherein the carbon dioxide displaces methane from hydrates.

5. The method of claim 1, wherein the trained machine learning model outputs hydrate equilibrium information.

6. The method of claim 5, wherein the hydrate equilibrium information is for carbon dioxide hydrates, methane hydrates, or carbon dioxide hydrates and methane hydrates.

7. The method of claim 1, comprising accounting for changes in permeability of the reservoir based at least in part on the hydrate information.

8. The method of claim 1, wherein performing the reservoir simulation simulates geomechanics.

9. The method of claim 1, wherein the injection of carbon dioxide depends on a combustion process at a surface facility.

10. The method of claim 9, wherein the surface facility combusts methane in the presence of oxygen to produce the carbon dioxide.

11. The method of claim 1, comprising identifying the reservoir.

12. The method of claim 11, wherein the identifying the reservoir comprises accessing the trained machine learning model to determine an ability of the reservoir to sequester carbon dioxide.

13. The method of claim 1, comprising generating the trained machine learning model.

14. The method of claim 13, wherein the generating comprises accessing field data and laboratory data.

15. The method of claim 13, wherein the generating comprises accessing pressure and temperature data for a plurality of hydrate compositions.

16. The method of claim 1, wherein the trained machine learning model comprises a random forest.

17. A system comprising:
one or more processors;
a memory accessible to at least one of the one or more processors;
processor-executable instructions stored in the memory and executable to instruct the system to:
perform a reservoir simulation for injection of carbon dioxide into a reservoir via an injection well;
during the reservoir simulation, access a trained machine learning model that outputs hydrate information based on reservoir conditions; and
based on the hydrate information, generate reservoir simulation results that indicate an amount of the carbon dioxide sequestered in the reservoir.

18. The system of claim 17, comprising processor-executable instructions stored in the memory and executable to instruct the system to generate the trained machine learning model.

19. The system of claim 17, comprising processor-executable instructions stored in the memory and executable to instruct the system to perform a geomechanics simulation.

20. One or more computer-readable storage media comprising processor-executable instructions to instruct a computing system to:
perform a reservoir simulation for injection of carbon dioxide into a reservoir via an injection well;
during the reservoir simulation, access a trained machine learning model that outputs hydrate information based on reservoir conditions; and
based on the hydrate information, generate reservoir simulation results that indicate an amount of the carbon dioxide sequestered in the reservoir.
